(19) United States
(12) Patent Application Publication
(10) Pub. No.: US 2018/0266172 A1
(43) Pub. Date: Sep. 20, 2018

(54) GARAGE DOOR SYSTEMS AND METHODS

(71) Applicant: BioFilm IP, LLC, Minden, NV (US)

(72) Inventors: Daniel X. Wray, Genoa, NV (US); Ericson C. Ceniceros, Reno, NV (US); Reed Nicholas Liu, Reno, NV (US); Anthony Zunino, Reno, NV (US); Olivia Tanguileg, Reno, NV (US); Benjamin Wallace, Henderson, NV (US); Khalid M. Rumjahn, JR., Reno, NV (US); Hunter A. Tyzbir, Reno, NV (US)

(21) Appl. No.: 15/920,315

(22) Filed: Mar. 13, 2018

Related U.S. Application Data
(60) Provisional application No. 62/471,328, filed on Mar. 14, 2017.

(51) Int. Cl. E06B 7/20; E06B 1/52; E06B 3/44; E05D 15/22; E05F 17/00; E06B 3/48; B32B 3/06; B32B 3/12; B32B 5/18; B32B 5/16; B32B 7/12; B32B 15/16; B32B 15/04; B32B 15/18; B32B 15/20; B32B 27/06; B32B 27/14

(52) U.S. Cl. CPC E06B 7/20; E06B 5/10; E06B 3/44; E05D 15/22; E05F 17/004; E06B 3/485; B32B 3/06; B32B 3/12; B32B 5/18; B32B 5/16; B32B 7/12; B32B 15/16; B32B 15/046; B32B 15/18; B32B 15/20; B32B 27/065; B32B 27/14; E06B 1/522

(57) ABSTRACT

Provided are door systems having a plurality of door panels and a frame, the door panels being movable between an extended position closing an opening in a building structure, and a folded retracted position. When in the extended position, the door panels interlock with each other forming a barrier to wind, dirt, dust and insects. The frame is movably attached to the building structure and when the door panels are in the extended position, the frame moves and engages the door panels with a sealing member to provide an airtight seal of the opening in the building structure.

### RELATED APPLICATIONS

Benefit of priority is claimed to U.S. Provisional Application No. 62/471,328, titled “GARAGE DOOR SYSTEMS AND METHODS,” filed Mar. 14, 2017, the subject matter of which is incorporated by reference herein in its entirety.

This application is related to International PCT Application No. (Attorney Docket No. 33348-9817PC), filed the same day herewith, entitled “GARAGE DOOR SYSTEMS AND METHODS,” which also claims priority to U.S. Provisional Application Ser. No. 62/471,328. The subject matter of the above-noted International application is incorporated by reference herein in its entirety.

### FIELD

The present invention relates generally to a door system having a plurality of door panels and a frame, the door panels being movable between an extended position closing an opening in a building structure, and a folded retracted position, opening the opening in the building structure. When in the extended position, the door panels interlock with each other forming a barrier to wind, dirt, dust and insects. The frame is movably attached to the building structure and, when the door panels are in the extended position, the frames moves until the panels engage with a sealing member to provide an airtight seal.

### BACKGROUND

Typical garage doors can include several sections interconnected by hinges that can be moved on a pair of rails or tracks and can be moved from a closed vertical position to an open horizontal position. The panels typically includes rollers at their edge, the rollers connected to the rails or in the tracks and allowing movement of the sections. The door is of a size so that it covers the entire opening of the building structure, e.g., garage. Because most garage doors include four sections, each section of an seven-foot having four sections would have a height of about 21, and each section of a typical eight-foot four-section door would have a height of about 24 inches. Because the door when in the open horizontal position has the same size as when it is in the closed vertical position, it occupies a large area of the ceiling that otherwise could be put to other uses, such as storage. Rolling garage doors that can be rolled up into a cylinder are known, but such doors offers little insulation properties, have very little esthetic properties and fail to seal out wind, dirt and insects.

Sectional overhead garage doors are known (e.g., see U.S. Pat. No. 3,618,656 (Young, 1971); U.S. Pat. No. 4,460,030 (Tsunemura et al., 1984); and U.S. Pat. No. 8,371,356 (Manser, 2013); and U.S. Pat. App. Pub. Nos. US2005/0072537 (Pfender, 2005) and US2010/0287840 (Godovalov, 2010)). Sectional overhead doors can include a plurality of horizontally oriented door sections pivotally connected together via hinges to form an articulated door. The door sections typically include sets of rollers at their ends that are supported between fixed rails or tracks that guide the movement of the door between a vertically oriented closed position to an overhead, substantially horizontal open position. The sections pivot relative to each other as the sections travel between the open and closed positions. Automatic garage door openers can be used to move the doors between the open and closed positions.

While the prior art describes articulated doors having adjacent panels connected to each other along horizontal edges with hinges to allow for movement of the panels, such arrangements can be mechanically complicated, often require special hinging arrangements to withstand the forces associated with panel movement between extended and stacked positions, and thus can be expensive to manufacture. Further, typical garage doors fail to keep out wind, dust and insects.

It is clear that there is a significant need for a more efficient and effective garage door systems for keeping out the elements, as well as dirt, dust, insects and pests, that can minimize the ceiling space occupied by the door when it is in an open position.

### SUMMARY

The present invention solves these and other problems which exist with existing garage door systems. An exemplary embodiment of the present invention provides a method and system for raising and lowering a garage door for closing an opening in a building or structure to prevent movement of air, dirt, dust, insects or pests into the building or structure.

It is an object of this invention to provide a door system that substantially reduces the entry of dirt, dust, insects and/or pests into a structure when the door is in the closed position, as well as minimizing the space occupied by the door when it is in the open position. The system can be used for such installations as sectional overhead garage doors and as a closure for building exteriors. The system can include interchangeable and easily replaceable panels that interlock to prevent movement of air, dirt, dust, insects or pests through the system when in the closed position.

Provided herein are sectional door systems for closing an opening in a building. The system includes a plurality of panels, each panel comprising a first face surface; a second face surface; a core; a first horizontal long edge containing a recessed groove and an opposite second horizontal long edge including a tongue portion, or a first horizontal long edge containing a positive of a half-lap joint, and an opposite second horizontal long edge containing a negative of a half-lap joint; a first vertical short edge on one end; and a second vertical short edge on the opposite end. The door systems also include a frame within which the panels can move, an operating mechanism for opening and closing the door vertically by moving the panels within the frame, a sealing member attached about the opening in the building, and a movable connector for movably connecting the frame to the building for reversibly engaging the panels with the sealing member to form an airtight seal.

In the systems provided, the tongue portion of one panel is insertable in the recessed area of an adjacent panel to join the panels and inhibit the passage of air therebetween, or the positive half-lap joint of one panel fits into the cutaway negative half-lap joint of the adjoining panel, thereby joining the first panel to the second panel and inhibiting the passage of air therebetween. The panels can include a core that includes a unitary expanded polymeric material. The expanded polymeric material can include a polystyrene foam or polyurethane foam or combinations thereof. The core can have a honeycomb design. The core can include an aerogel. The core can include a plurality of insulation microspheres. The core can include one or more vacuum insulated panels.

The panels or the door can include an insulating material to reduce the transmission of thermal energy or sound energy or both. The panels can have a layered composite construction, with different materials layered during fabrication of the panel. The panel can be manufactured so that the panel has no visible seams. The panel can be configured to have a thermal resistance or R value ranging from 30 to 60. The panels can be configured so that the first face surface of the panel faces external to the opening of the building or structure, and the second face surface of the panel faces internal to the opening of the building or structure. The first face surface and second face surface each can include a material independently selected from among plastic, aluminum, aluminum alloy, aluminum composite, carbon fiber, and steel. The first face surface or second face surface or both can be or can include a thermoplastic resin, or resin reinforced fiberglass, or carbon-fiber-reinforced plastic, or a composite or a combination thereof. The first face surface or second face surface can be or include an epoxide resin based carbon fiber-reinforced plastic. The first face surface or second face surface can be or include acrylonitrile butadiene styrene copolymer (ABS), polycarbonate acrylonitrile butadiene styrene copolymer (PC/ABS), polyether-ether-ketone (PEEK), polyetherketone ketone (PEKK), polyetherimide (PEI), polypropylene (PP), polyphenylene sulfide (PPS), polyvinyl chloride (PVC), or a thermoplastic olefin (TPO) or any combination thereof.

In the door systems provided herein, the panels can include a surface coating. The surface coating can include a thermoplastic elastomer, a thermoplastic vulcanizate or an aromatic polyurea/polyurethane hybrid elastomer system or combinations thereof. The surface coating can include Line-X® brand aromatic polyurea/polyurethane hybrid protective coating. The surface coating can be on an internal surface of the panel, or the first face surface, or the second face surface or any combination thereof. The tongue portion of each panel can include a metal insert. The metal insert can have a shape selected from among a rod, a strip, a square bar, a rectangular bar, a hexagonal bar, a sheet and a corrugated sheet. The metal insert can extend into the core of the panel. The core can be between the first face surface and second face surface of the panels and adhesively bonded thereto to form a unitary unit.

In the door systems provided herein, at least one panel can include a window. The window can include a polymer film. The polymer film can be a polyvinylbutyral (PVB) or ethylene vinyl acetate (EVA) or a combination thereof. The window can include a privacy glass. The window can include an electro-chromic element. The window can include at least two layers of transparent material separated by a space. The space between the two layers of transparent material can be evacuated or filled with an inert gas. The window can include a transparent metal oxide layers that can reflect at least one wavelength of electromagnetic radiation.

In the door systems provided herein, at least one panel can include a decorative design or embossment. The decorative design or embossment can be on a face surface positioned toward the exterior environment or toward the interior of the building or both. The panel can have one decorative design or embossment on one face surface and a different decorative design or embossment on the other face surface. At least one face surface can include a coating selected from among a paint, a pigment, a vinyl cladding, a baked-on polyester finish, melamine, a powder coating, an anti-corrosive coating, a galvanizing coating, and any combination thereof. The door systems can include an interchangeable cover that can be fastened to the first face surface or the second face surface or both to change the aesthetic appearance of the door. The panels can have a thickness of from about 0.5 to about 3 inches. The panels also can include a coupling joining adjacent panels. The coupling can be or include a hinge. The coupling can secure adjacent panel members together along adjoining first and second horizontal long edges. The coupling can secure adjacent panel members together along adjoining first and second vertical short edges. The coupling can include a slidable ring that encircles a first peg on one panel and a second peg on an adjacent panel and is configured to couple the first and the second pegs while allowing the panels to rotate about their horizontal long edges.

In the door systems provided herein, a surface of the recessed groove or a surface of the negative of the half-lap joint of the panels can include a compressible elastomeric material. The compressible elastomeric material can be or contain rubber, vinyl, polyolefin foam, synthetic polyisoprenes, polybutadienes, polychloroprenes, chlorosulfonated polyethylenes, elastomeric polyurethanes, fluorinated elastomers, isoprene-isobutylene copolymers, ethylene-propylene-diene copolymers, styrene-isoprene-styrene block copolymers, styrene-ethylene-butylene-styrene block copolymers, or a combination thereof. The recessed groove of the panels can be of any shape, such as a shape selected from among rectangular, tapered and U-shaped.

The frame can include a pair of vertical tracks and the panels can be positioned between the vertical tracks. The vertical tracks can contain rollers that allow the panels to move within the track without contacting the track directly. The rollers can include a material selected from among nylon, plastic, wood and metal. The rollers can include a coating selected from among an elastomeric coating, a polymer coating, a Teflon coating, a plastic coating and a nylon coating. Each of the vertical tracks can include a first straight section that is parallel to the opening of the building or structure. Each of the vertical tracks can include a curved portion near the top of the opening of the building or structure positioned toward the inside of the building. Each of the vertical tracks can include a distal second straight section that is parallel to and spaced from the ceiling of the structure. At least one of the vertical tracks can include a limit switch that de-energizes the operating mechanism when contacted. The frame can include a horizontal cross member. The system can include a fixed support fixedly attached to the structure. The fixed support can be attached to the ceiling of the structure. The fixed support can be attached to the wall of the structure. The tracks of the frame can be attached via movable rails to the fixed support. The fixed support can be configured to accept the terminal portion of the frame without interfering with the movement of frame as it is moved toward or away from the opening of the building or structure. At least one of the tracks of the frame can include at its terminus an end stop. The terminus of the tracks or the end stop or both can include a surface coating. The surface coating can include an elastomeric coating. The elastomeric coating comprises polytetrafluoroethylene, polyamide, perfluoroelastomer, rubber, vinyl, polyolefin foam, synthetic polyisoprenes, polybutadienes, polychloroprenes, chlorosulfonated polyethylenes, elastomeric polyurethanes, fluorinated elastomers, isoprene-isobutylene copolymers, ethyl ene-propylene-diene copolymers, styrene-isoprene-styrene block copolymers, styrene-ethylene-butylene-styrene block copolymers, or combinations thereof.

The door systems provided herein can include a light activated when the door operating mechanism is energized. The door systems can include a receiver responsive to a transmitter. The door systems can include an obstruction sensor or a reverse trip switch or both. The obstructions sensor can include an infrared optical sensor. The door systems can include a manual switch to deactivate the door system. The door systems can include a carbon monoxide sensor and an alarm. The door systems can include a smoke detector and an alarm. The door systems can include an infrared tripping sensor. The door systems can include a variable resistance sensor. The door systems can include a particle detector or air quality sensor.

The door systems can include a computer module. The computer module can include a computer in communication with and/or in control of any part of the door system. The computer can communicate with a control system to automate or operate the opening and closing of the door. The computer can communicate with a control system to operate a light, a mechanical component, an operating mechanism, a touch panel, or automatic closing and locking mechanisms or any combination thereof. The computer module can include a non-transitory computer-readable storage medium having a computer-readable program embodied therein for directing operation of the door system and/or any component of the system. The door systems provided herein can be configured to interact with a smart house product. The door system can be configured to interact with a smart phone.

In the door systems provided herein, the sealing member can include a compressible material that is reversibly deformable and conforms in shape to the surface of an object brought into contact with the sealing member. The compressible material can be or contain a sponge rubber or a foamed plastic or a plastic resin or a compressible elastomeric material comprising rubber, vinyl, polyolefin foam, synthetic polyisoprenes, polybutadienes, polychloroprenes, chlorosulfonated polyethylenes, elastomeric polyurethanes, fluorinated elastomers, isoprene-isobutylene copolymers, ethylene-propylene-diene copolymers, styrene-isoprene-styrene block copolymers, styrene-ethylene-butylene-styrene block copolymers, or combinations thereof. The sealing member can be or contain a resilient semi-circular strip of elastomeric compressible material. The sealing member can be or include a hollow opening in the interior of the sealing member that extends the length of the material. The sealing member can include an elastomeric reservoir containing a quantity of fluid secured to a header above the opening of the building or structure and spaced tubular elastomeric members secured at each side of the door opening to the building structure, where fluid forced into the tubular members extend them into sealing contact with the side edges of the panels of the door.

In the door systems provided herein, the movable connector can include an electro-mechanical connector, an electric-hydraulic connector, a hydraulic connector, a pneumatic connector, an electro-pneumatic connector, a solenoid valve connector, a mechanical spring connector, or a combination thereof. The movable connector can include a threaded member that can move the frame toward the building or structure to engage with the sealing member to form a seal, and move the frame away from the building or structure to disengage with the sealing member. The movable connector can include a pair of metal plates that contain an internally threaded opening that accepts the threaded member. One metal plate of the pair can be attached to an element of the structure, and the other metal plate of the pair can be attached to the frame, and rotation of the threaded member by a motor in one direction repositions the frame toward the opening of the building or structure, and rotation of the threaded member by the motor in the opposite direction repositions the frame away from the opening of the building or structure. The motor can be a direct-current motor driven by a power control signal or a stepper motor. The door system or the movable connector can include a control circuit programmed to control rotation of the motor in the forward and reverse directions. The movable connector can include a pair of arms, disposed symmetrically around a central axis, and a piston to push the arms apart or to pull the arms together, thereby bringing the frame toward or away from the building or structure opening. The piston can be operated electrically, hydraulically or pneumatically. The movable connector can include a gear attached to a drive shaft, a motor, and a cable or chain driven by the motor to rotate the gear and drive shaft to reposition the frame of the door closer to or away from the building or structure opening.

In the door systems provided herein, the door operating mechanism can include a mechanical opener, an electromechanical opener, an electrical opener, a hydraulic opener, a pneumatic opener or combinations thereof. The door operating mechanism can include an electric motor, a chain drive mechanism, and a length of a bicycle-type chain geared to the chain drive mechanism driven by the electric motor. The door operating mechanism can include a pair of actuator arms that can lift and stack the panel members of the door into a stack. The actuator arms can include a clamp or fingers at their distal ends to engage with the panel. The clamp or fingers can be operated electrically, hydraulically or pneumatically. The door systems can include a rail or track on which the actuator arms are mounted. The door operating mechanism can include an electric motor, a drive mechanism, and a length of toothed belt geared to the drive mechanism driven by the electric motor. A weather seal can be attached to the tongue portion of the bottom-most panel.

Also provided are methods for sealing an opening of a garage or other structure. The methods include providing a door system as provided herein and attaching it to the garage or other opening via the movable connector, and activating the operating mechanism to position the panels in their closed position, in which the tongue portion of one panel is received into the recessed groove of an adjacent panel, joining the panels and inhibiting the passage of air therebetween; and activating the movable connector to advance the frame until the panels are in contact with and form a seal with the sealing member about the opening of the garage or structure.

Also provided are methods for reversibly converting a garage space into a living space. The methods include sealing any vents or drains in the garage, and installing a door system provided herein. Once the door system is attached to the garage or other opening via the movable connector, the operating mechanism can be activated to position the panels in their closed position, in which the tongue portion of one panel is received into the recessed groove of an adjacent panel, joining the panels and inhibiting the passage of air therebetween; and the movable connector is activated to advance the frame until the panels are in contact with and form a seal with the sealing member about the opening of the garage or structure.

Other objects, features and advantages of the systems and methods described herein will become apparent to those skilled in the art from the following detailed description. It is to be understood, however, that the detailed description, while indicating certain embodiments of the systems and methods described herein, are given by way of illustration and not limitation. Many changes and modifications within the scope of the present invention may be made without departing from the spirit thereof.

### DETAILED DESCRIPTION

### Brief Description of the Figures

The drawings described herein are for illustrative purposes only of selected embodiments and not all possible implementations, and are not intended to limit the scope of the present disclosure.

FIG. 1A is a side cutaway view (looking through a vertical support of the door frame) of a schematic view of an exemplary door frame system in a position ready for the door to open. FIG. 1B is a side cutaway view (looking through a vertical support of the door frame) of a schematic view of an exemplary door frame system in a closed position.

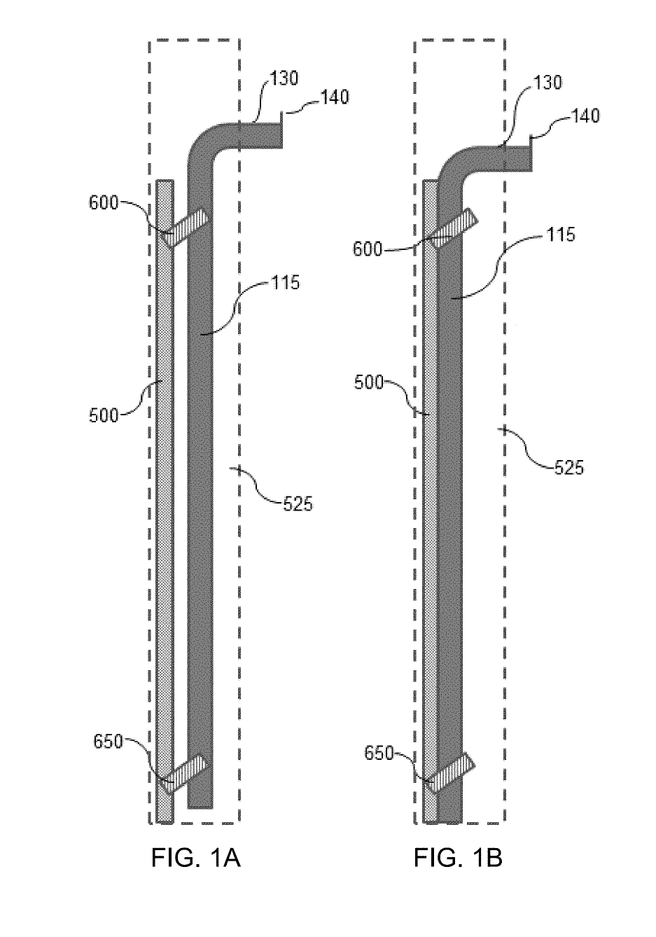

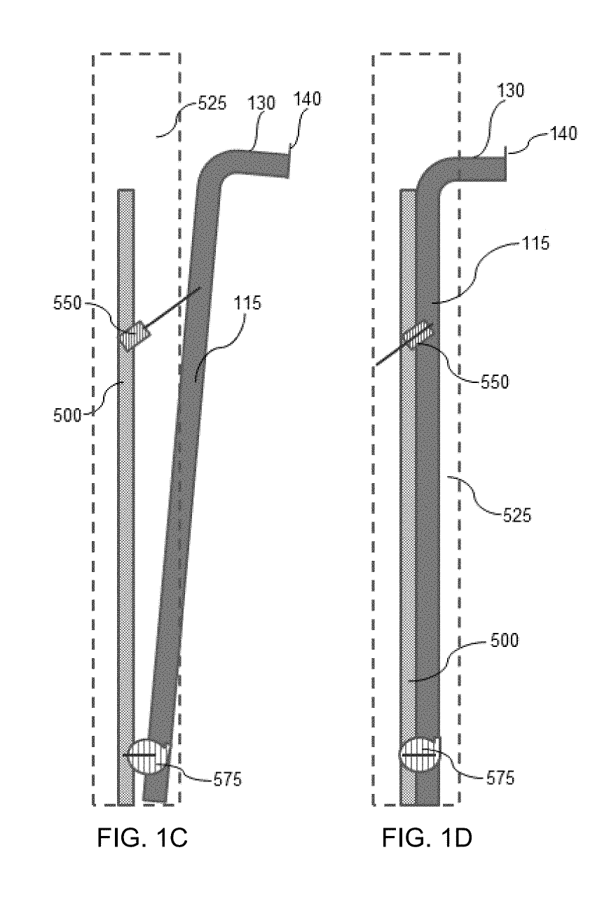

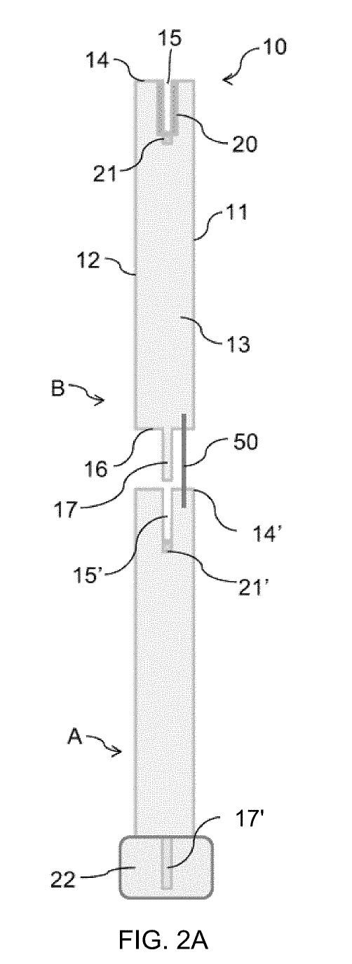

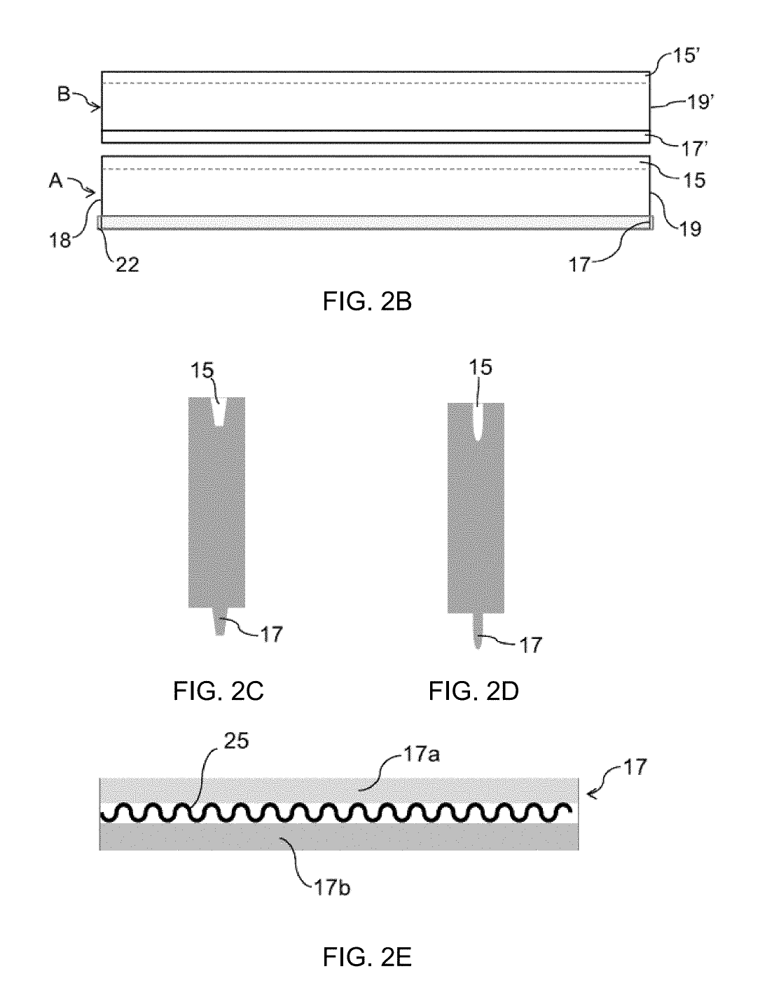

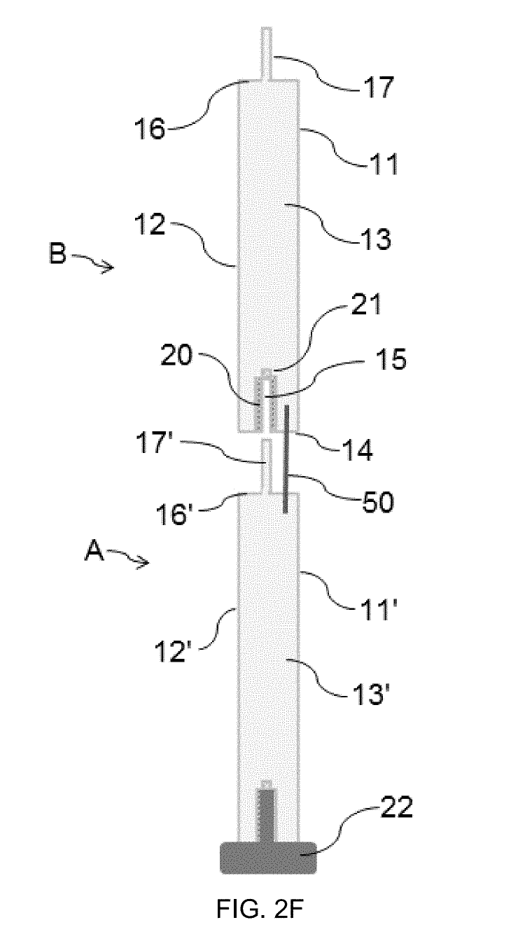

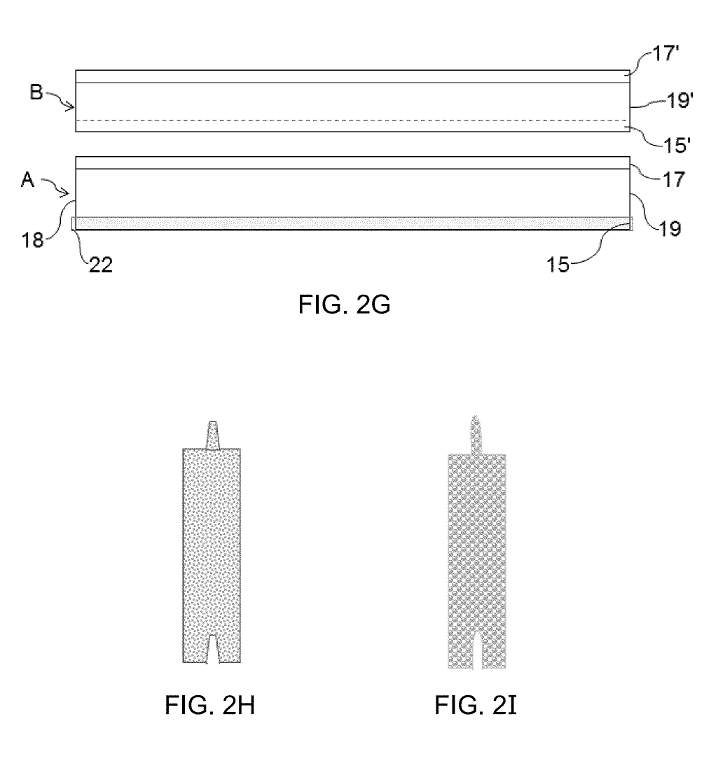

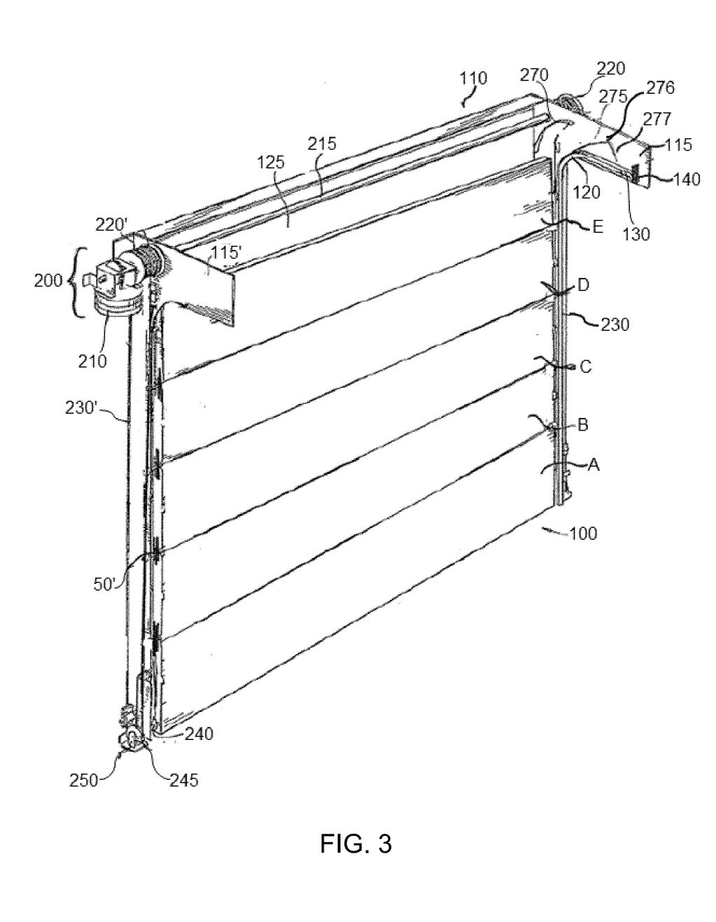

The embodiments of FIGS. 1A and 1B include an upper movable connector 600 and lower movable connector 650 that move the vertical side 115 of the door system frame. FIG. 1C is a side cutaway view (looking through a vertical support of the door frame) of a schematic view of an exemplary door frame system in a position ready for the door to open. FIG. 1D is a side cutaway view (looking through a vertical support of the door frame) of a schematic view of an exemplary door frame system in a closed position. The embodiments of FIGS. 1C and 1D include an movable connector 550 near an upper portion of the door system frame and a pivot joint 575 near a lower portion of the door system frame. In the configurations shown in FIGS. 1C and 1D, the action of the movable connector 550 results in a zipper effect as the door system frame is brought toward or pushed away from the opening sealing element.

FIG. 2A is a side view of a schematic view of two panels of the door system provided herein. Panels A and B are shown. The view is looking at the vertical short edge of the panel, depicting an exemplary configuration of the recessed grooves 15 and the interlocking tongue portions 17. A weather seal 22 is shown attached to the tongue portion 17′ of the bottom panel A.

FIG. 2B is a front view of a schematic view of two panels of the door system provided herein. Panels A and B are shown.

FIGS. 2C and 2D are side views of a schematic view of a single panel. FIG. 2C shows a panel having a tongue and groove that is tapered so that is wider at the top and narrower at the bottom. FIG. 2D shows a panel having a tongue portion and a groove portion that each have a rounded or U-shaped bottom.

FIG. 2E is a top view of a sectional view of a tongue portion 17 containing a metal insert 25.

FIG. 2F is a side view of a schematic view of two panels of the door system provided herein. Panels A and B are shown. The view is looking at the vertical short edge of the panel, depicting an exemplary configuration of upward-directed tongue portions 17 and interlocking recessed grooves 15. A weather seal 22 is shown attached via the recessed groove 15 of the bottom panel A.

FIG. 2G is a front view of a schematic view of two panels of the door system provided herein. Panels A and B are shown, the panels each having an upward-directed tongue portion 16 on an upper portion of the panel and an interlocking recessed groove 15 on a lower portion of the panel.

FIGS. 2H and 2I are side views of a schematic view of a single panel. FIG. 2H shows a panel having a tongue and groove that is tapered so that is wider at the top and narrower at the bottom. FIG. 2I shows a panel having a tongue portion and a groove portion that each have a rounded or U-shaped bottom.

FIG. 3 is a skewed back view of an exemplary configuration of the door system provided herein.

Corresponding figure elements indicate corresponding parts throughout the several views of the drawings. For parts which are similar but not the same as parts originally specified with a given number, a prime (′) of the original number(s) is used.

Some components of the system of the present invention include right side components identical to the left side components. In the figures, only one side of the components may be illustrated due to the perspective of the figure, with the understanding that the identical components on the opposite side are present but omitted for clarity of the drawings.

The drawings in the present application and their accompanying detailed description are directed to merely exemplary implementations. The drawings are generally not to scale, some of the dimensions are for the clarity of presentation and are shown exaggerated in the drawings, and are not intended to correspond to actual relative dimensions. Certain elements in some of the figures may be omitted, or illustrated not to scale, for illustrative clarity. The cross-sectional views may be in the form of “slices”, or “near-sighted” cross-sectional views, omitting certain background lines which would otherwise be visible in a “true” cross-sectional view, for illustrative clarity. Further, only those elements which are useful to the understanding of the present invention have been shown and described. Although the views in the drawings for ease of description generally show similar orientations, this depiction in the drawings is arbitrary for the most part and the device could be illustrated and operated in any orientation.

### A. Definitions

Unless defined otherwise, all technical and scientific terms used herein have the same meaning as is commonly understood by one of skill in the art to which the inventions belong.

All patents, patent applications, published applications and publications, websites and other published materials referred to throughout the entire disclosure herein, unless noted otherwise, are incorporated by reference in their entirety.

In the event that there are a plurality of definitions for terms herein, those in this section prevail.

As used here, the singular forms “a,” “an” and “the” include plural referents unless the context clearly dictates otherwise.

As used herein, ranges and amounts can be expressed as “about” a particular value or range. “About” also includes the exact amount. Hence “about 5 percent” means “about 5 percent” and also “5 percent.” “About” means within typical experimental error for the application or purpose intended.

As used herein, “optional” or “optionally” means that the subsequently described element, event or circumstance does or does not occur, and that the description includes instances where the element, event or circumstance occurs and instances where it does not.

For example, an optional component in a system means that the component may be present or may not be present in the system.

As used herein, an “articulated door” refers to a door having two or more sections connected by a hinge or mechanical flexible joint.

As used herein, a “sectional door” refers to a door containing a plurality of panels or sections.

As used herein, a “hermetically sealed” refers to something that excludes the passage of air.

As used herein, “insulation microspheres” refers to hollow bubbles or beads that help to reduce thermal conduction. The microspheres typically are 500 μm, and can be in the size range 0.1 to 500 μm.

As used herein, a “movable connector” is a connector that movably joins one object in relation to another object, and in particular is a connector that can be fixed to a building structure and a door system frame and can move the frame toward and away from the building structure.

### B. Door Systems

Provided herein are garage door systems that will greatly reduce or eliminate the problems common in prior art garage door devices. The garage door systems provided herein form an air tight seal of an opening of the building or structure, such as a doorway, prohibiting wind, dirt, dust pests and insects from entering the structure. The garage door systems provided herein minimize the ceiling space occupied by the door when in the open position. Although the principles of the present invention are described partly in connection with residential garages and it is particularly advantageous in such usage, it should be understood that this is merely by way of example and that the invention has equal application for any type of overhead doors and can be applied to other types of buildings, such as in sheds, storage facilities, equipment storage buildings, and warehouses.

Unlike traditional garage doors, which move on a fixed frame attached to the structure, the garage door systems provided herein include a door system frame that is movably attached to the structure, allowing the door to be moved against a sealing member fixed to the structure to form a seal when the door is closed, and allowing the door to be moved away from the sealing member when the door is to be opened. The door system frame is moveably connected to an opening of a structure, such as a doorway in a garage. The opening generally is defined by a horizontal header and a pair of vertical beams located at either end of the opening of the building or structure.

The movable connector can be installed so that when the door is to be opened, the connector moves the door away from the opening and slightly upward, such as from 0.2 to 1 inch, so that the bottom of the door moves upward away from the bottom track. A sealing member attached to the bottom-most panel thereby is lifted so that it is not in contact with the track or the floor of the building, eliminating frictional wear that otherwise would be applied to the sealing member. This prolongs the life of the sealing member. When the door closes, the movable connector brings the door toward the opening and downward toward the floor, pressing the sealing member of the bottom-most panel against the floor, creating an airtight seal.

The door system frame can be moveably connected to the structure, such as a building doorway, using an electro-mechanical connector, an electric-hydraulic connector, a hydraulic connector, a pneumatic connector, an electro-pneumatic connector, a solenoid valve connector, a mechanical spring connector, or a combination thereof. Exemplary devices that can be used or modified for use are described, e.g., in U.S. Pat. No. 3,554,087 (Florjancic (1971); U.S. Pat. No. 4,523,513 (Gudat et al., 1985); U.S. Pat. No. 5,592,972 (Niethammer (1997); and U.S. Pat. No. 7,059,165 (Siegert et al., 2006). The frame system can be movably connected to the structure using a plurality of connectors.

The garage door systems provided herein form an airtight seal of an opening of a building or structure, such as a doorway or garage opening, prohibiting wind, dirt, dust pests and insects from entering the structure. The garage door systems provided herein minimize the storage space occupied by the door when in the open position. Although the principles of the present invention are described partly in connection with residential garages and it is particularly advantageous in such usage, it should be understood that this is merely by way of example and that the invention has equal application for any type of overhead doors and can be applied to other types of buildings, such as in sheds, storage facilities, airplane hangars, equipment storage buildings, and warehouses.

In some applications, the frame of the garage door system provided herein can be moveably connected to the structure, such as to an element of a building opening, such as a support of a doorway, using an electro-mechanical connector. The electro-mechanical connector can include a motor driven threaded member connected to a corresponding receiving member. In some configurations, the electro-mechanical connector can include a motor driven threaded member attached to the door system frame and a corresponding receiving member attached to an element of the structure, such as an element of the building opening, e.g., a stud or header of a doorway opening. In some configurations, a motor driven threaded member can be attached to an element of the structure, such as an element of the building opening, and a corresponding receiving member can be attached to the door system frame.

The electro-mechanical connector can include a pair of metal plates that contain an internally threaded opening that accepts a threaded member, such as a screw or bolt. The metal plates are spaced apart but connected via the threaded member. One metal plate of the pair can be attached to an element of the structure, and the other metal plate of the pair can be attached to the door system frame. Rotation of the threaded member by a motor in one direction repositions the door system frame toward the opening of the building or structure, and rotation of the threaded member by the motor in the opposite direction repositions the door system frame away from the opening of the building or structure.

A plurality of metal plates can be fixedly attached about the opening of the building or structure. For example, a metal plate can be located on the interior of the building attached to each vertical beam of a doorway opening. In some configurations, each vertical beam of the doorway opening can include two metal plates spaced apart. In some configurations, each vertical beam of the doorway opening include a metal plate near the bottom of the doorway opening and a metal plate near the top of the doorway opening. Each metal plate includes an internally threaded opening that can accept a threaded member, the internally threaded opening of each metal plate corresponding to an internally threaded opening of a corresponding metal plate of a pair. A motor drives the rotation of the threaded member, the rotation in one direction bringing the metal plates together, and the rotation in the opposite direction moving the plates apart. The motor can be attached to the door system frame, and the motor can drive the rotation of the threaded member that is engaged with an internally threaded opening in a metal plate attached to an element of the building structure, such as an element of the doorway opening.

The motor can be a conventional direct-current (DC) motor driven by a power control signal, or can be a stepper motor that allows a precise amount of rotation of the threaded member by electronically controlling the number of energizing pulses supplied to the motor. The motor can operate to rotate in the forward and reverse directions. A control circuit can be programmed to control rotation of the motor in the forward and reverse directions in response to an indication that the door is to be opened or closed. The motor can include an electronic control unit in communication with the motor that can be programmed to stop rotation of the motor virtually instantaneously once the door system frame has been moved sufficiently toward the opening of the building or structure to engage the panels with the sealing member to seal the opening of the building or structure, such as a doorway.

The frame of the garage door system provided herein can be moveably connected to the structure, such as to a structural element of a doorway opening, using a hydraulic or pneumatic connector. The hydraulic or pneumatic connector can include a pair of arms, disposed symmetrically around a central axis, the arms being pivotably mounted at points on the periphery of the apparatus. A hydraulically-operated piston can be used to push the arms apart or to pull the arms together, thereby bringing the door system frame toward or away from the sealing member around the opening of the building or structure. The arms can be connected to a common yoke disposed along the axis of symmetry of the arms, and are pushed apart or pulled together by a piston. The piston can be attached to the yoke and can be hydraulically or pneumatically operated. In some applications, the piston is hydraulically operated, which through the use of appropriate valves, can direct a fluid into a region on either side of the piston, forcing the piston to move in the desired direction. The movement of the piston forces the arms apart or together, according to the direction of the piston. The hydraulic system can include flexible hoses with quick-connect couplings as pressure lines and can include appropriate check valves.

The frame of the garage door system provided herein can be moveably connected to the structure, such as to a structural element of a doorway opening, using a chain or cable or a combination thereof. The connector can include a combination of gears and drive shafts, a motor, and a cable or chain driven by the motor to rotate the gears and drive shafts to reposition the frame of the door closer to or away from the doorway opening. The gears can be bicycle-type sprockets mounted on the drive shaft(s) and bicycle-type chains can engage the sprockets.

The door system frame includes a pair of generally parallel tracks which can guide the movement of the panels of the door. The tracks include a first straight section that are parallel to the opening of the building or structure. The tracks can extend in a curved portion near the top of the opening of the building or structure toward the inside of the building. The tracks then continue along a distal straight section that is located parallel to and spaced from the ceiling of the structure. When the door operating mechanism operates to open the door, the door moves in the tracks of the door frame system until the door reaches a fully open position. The distal end of the tracks can include a limit switch that de-energizes the motor to stop garage door travel when contacted, e.g., by a portion of a panel of the garage door.

The tracks can include rollers that allow the door panels to move within the track without contacting the track directly, thereby protecting the finish of the panel from wear due to contact with the track. The rollers can be nylon, plastic or wooden, or can be metal containing a coating of a material that protects the finish of the panels of the door. For example, the rollers can include an elastomeric coating, a plastic coating, or a polymer coating, such as a Teflon or nylon coating.

The frame can include an upper horizontal cross member at the top of the frame. The horizontal cross member can provide structural support to the frame. The upper horizontal cross member can be connected to the vertical sides of the frame. The vertical sides can contain a vertical track. Each vertical track can include an end portion that can make up a landing portion on which the door panels can land or be stacked or both. The vertical tracks can include an end stop at the terminus of the tracks, e.g., after the landing portion. The end stop can include a vertically oriented metal sheet or beam. In some configurations, the end stop can help to maintain the panels in a vertical position during storage when the door is in the open position. In some configurations, the end stop can prevent the panels from falling off the landing portion when the door is in the open position.

The door frame system can include a support fixedly attached to the building structure. In some configurations, the fixed support is attached to the ceiling of the building structure. The support can function as a storage area onto which the panels of the door can rest when the door is in the open position. The tracks of the door system frame can move free of the support, allowing the door system frame to move toward and away from the opening of the door. In some configurations, the tracks of the door frame system can be attached via movable rails to the fixed support. The landing portion of the door frame system can be positioned so that it is in movable contact with and supported by the fixed support, but the fixed support does not interfere with the movement of the frame as the frame is moved toward or away from the doorway opening.

A portion of the terminus of the tracks, e.g., the landing portions, and the end stops (when present) of the door system frame can include a surface coating of an elastomeric coating. In some configurations, an area equal to the combined thicknesses of all of the panels of the door at the terminus of the tracks includes a surface coating. The elastomeric coating can help to minimize any surface damage, such as scratches or wear, of the surfaces of the panels during opening and closing of the door. The elastomeric coating can be or contain polytetrafluoroethylene, polyamide, perfluoroelastomer, rubber, vinyl, polyolefin foam, synthetic polyisoprenes, polybutadienes, polychloroprenes, chlorosulfonated polyethylenes, elastomeric polyurethanes, fluorinated elastomers, isoprene-isobutylene copolymers, ethyl ene-propylene-diene copolymers, styrene-isoprene-styrene block copolymers, styrene-ethylene-butylene-styrene block copolymers, and combinations thereof.

The fixed support can include a light activated when the door operating mechanism is energized. The light can have a time delay mechanism that keeps the light in an illuminated state for a predetermined period of time after the door operating mechanism is energized. After the set period, the light is extinguished.

The door frame system can include a receiver responsive to a transmitter. The transmitter can be used to activate the door operating mechanism. The transmitter can be a wireless transmitter, located in the vehicle, or located within the structure, or carried by the operator of the vehicle, or programmed into a smart phone or other computer application software. The transmitter can provide a signal wirelessly to the receiver to open or close the door. The door frame system can include a wall switch connected to the receiver by wiring to actuate the motor. The signal can be an electrical signal transmitted by closure of a push-button switch through electrical wires or by radio frequency from a battery-operated, remote controlled actuating unit. In either case the electrical signals initiate movement of the garage door from the opposite condition in which it resides. If the original state of the garage door is the open position, the actuating signal closes it. Alternatively, when the original state of the garage door is the closed position, the actuating signal will open the garage door. Once movement has been initiated, the system can be deactivated when the garage door movement trips a limit switch as the garage door approaches its open or closed position.

The door frame system can include an obstruction sensor or a reverse trip switch or both. In some configurations, the door frame system can include a pair of photo-eye sensors mounted to project a beam of light of any wavelength across the opening of the building or structure which, when interrupted by an object as the door is closing, will reverse movement of the door to its open position in accord with the Underwriters Laboratories, Inc. (UL) Standards Technical Panel (STP) for ANSI/UL 325, Safety for Door, Drapery, Gate, Louver, and Window Operators and Systems. Preferably, infrared light optical sensors for an auto-reverse safety system are mounted interiorly on the door system frame, on both sides of the opening of the building or structure, such as a doorway. The infrared optical sensor projects a beam across the opening of the building or structure that detects people or objects that are in the way of the closing door. Any obstruction sensing door reversing device can be included (e.g., see U.S. Pat. No. 4,924,159 (Olson, 1990) and U.S. Pat. App. Pub. No. US2009/0313898 (Manaras, 2009)).

The door frame system can include a manual switch to deactivate the garage door system, which prevents the door frame from moving toward or away from the doorway opening, or the door from opening or closing. The door frame system can include a carbon monoxide sensor and an alarm. The carbon monoxide sensor can be connected to the door operating mechanism. If carbon monoxide levels build within the closed garage area to a dangerous level, an alarm will sound and the carbon monoxide sensor will send a signal that can trigger the door operating mechanism to open the closed garage door (e.g., see U.S. Pat. No. 7,183,933 (Dzurko et al., 2007); U.S. Pat. No. 7,515,058 (Normand, 2009); U.S. Pat. No. 7,710,284 (Dzurko et al., 2010); U.S. Pat. No. 8,669,878 (Vantilburg, 2014); and U.S. Pat. No. 8,803,696 (Dunyan, 2014)). The structure can include other ventilating systems that can remove carbon monoxide, noxious fumes or odors from the closed structure when the door is in the closed position (e.g., see U.S. Pat. No. 6,386,969 (O'Brien, 2002); U.S. Pat. No. 9,163,845 (Carlozzi, 2015); and U.S. Pat. App. Pub. Nos. US2006/0061313 (Fitzgibbon et al., 2006) and US2009/0124189 (Barber, 2009)).

In the garage door system provided herein, the door system includes a plurality of panels such that, when the door is opened, the panels move upward and can be stacked in a vertical direction against one another, or in a horizontal direction with each panel on top of an adjacent panel, forming a compact unit for storage. In the broadest context, the garage door system includes components configured and correlated with respect to each other so as to attain the desired objective of forming a seal with the opening of the building (e.g., a garage) and occupying less ceiling space in the open position than typical garage doors. The entire door system assembly is moved to engage the panels with the sealing member to seal the opening of the building or structure, such as a doorway.

The garage door system provided herein includes a plurality of panel members. The panel member can have an exterior surface of a sheet metal, such as aluminum, steel, or combinations thereof bonded to a central core material, such as an expanded foam. The panel members can be substantially constructed of molded plastic.

Each panel member typically has two horizontal edges (long edges) and two orthogonal vertical edges (short edges). A panel member has two face surfaces, a core, a first horizontal long edge containing a recessed groove, and an opposite second horizontal long edge containing a tongue portion extending outwardly from the panel. The recessed groove of the first horizontal edge can act as a mortise, and the tongue portion of the second horizontal edge can act as a tenon. The recessed groove of one panel is sufficiently deep relative to the tongue portion of a second panel to receive the tongue portion of the second panel and thereby join the first panel to the second panel.

The tongue portion of a panel can include a metal insert. The metal insert can strengthen the tongue portion of the panel. The metal insert can run the full horizontal length of the panel in tongue portion or can occupy only a portion of the horizontal length of the panel. The metal insert can be in the shape of a rod, strip, square bar, rectangular bar, hexagonal bar or a sheet or corrugated sheet. The metal insert can be a length of corrugated steel sheet. The metal insert can have a dimension such that it occupies only a portion of the full width of the tongue portion or a dimension such that it occupies substantially the full width of tongue portion. The metal insert can be fixed in the tongue portion. It can be fixed by fastening using staples, screws, nails, adhesive such as glue or any combination thereof. The metal insert can be embedded in the same material as the core. The metal insert can extend some distance above the tongue portion into the core of the panel to provide resistance to torsional forces.

Each panel member can be independent of other panel members, being joined together by the recessed groove panel of one panel receiving the tongue portion of another panel. Adjacent panel members can be joined together with a hinge that allows the panels to rotate about each other in an accordion fashion. One or more hinges can connect adjacent panel members. The hinge(s) can be placed and/or configured so that the adjacent panel members can be positioned so that the face surface of one panel is adjacent to the face surface of another panel.

Adjacent panels can be connected by a panel end coupling (e.g., an exemplary embodiment is shown as panel end coupling 50 or 50′ in FIGS. 2A, 2F and 3). The panel end coupling can be positioned on the short edge of the panel, and can join adjacent panels while allowing sufficient movement between the panels so that the panels can be positioned so that the face surface of one panel is adjacent to the face surface of another panel. Any moveable end coupling that allows for radial movement about the horizontal long edge of the panels can be used. In some configurations, the panel end coupling includes a cable attached to the short edge of adjacent panels. The cable can be attached to the edge of the panel using, e.g., a screw, bolt, staple, nail or any combination thereof. In some configurations, the panel end coupling includes a slidable ring coupling, where the slidable ring coupling encircles a first peg on the first panel and a second peg on the second panel and is configured to couple the first and the second pegs while allowing the panel to rotate about their horizontal long edges, which permits the panels to be positioned so that the face surface of one panel is adjacent to the face surface of another panel. The panel end couplings make it possible for the door to be folded when opened, and to assume the appropriate configuration when the door is closed.

The recessed groove of the panel member can include along its sides or along its bottom or both a compressible elastomeric material. The compressible elastomeric material can be or contain rubber, vinyl, polyolefin foam, synthetic polyisoprenes, polybutadienes, polychloroprenes, chlorosulfonated polyethylenes, elastomeric polyurethanes, fluorinated elastomers, isoprene-isobutylene copolymers, ethylene-propylene-diene copolymers, styrene-isoprene-styrene block copolymers, styrene-ethylene-butylene-styrene block copolymers, and combinations thereof. When present, the compressible elastomeric material can be configured so that it does not interfere with the nesting or interfitting relationship between the tongue portion of one panel and the recessed groove or another panel. When present, the compressible elastomeric material is arranged so that it does not interfere with the ability of the respective panels to pivot or rock relative to one another, as is typically necessary in connection with sectional garage doors. The elastomeric material can allow some movement of the interconnected panels without allowing the passage of air, dirt, dust, insects or pests through the interconnected panels.

The tongue portion and the recessed groove can have any complementary shape that allows the recessed groove of one panel member to receive the tongue portion of another panel. Exemplary shapes include a rectangular open mortise, a tapered mortise, and a curved bottom open mortise having a rounded bottom or U-shape. The intermeshing of the tongue and groove of the two panels bridges sheer forces and tensile forces between the core panels across the intermeshing joint as well as torsional stress. The intermeshing of the tongue and groove also stabilizes the panels relative to each other. The interlocked panels exhibit substantial resistance to bending, for example, when subjected to high wind loading.

The door panels can be configured to exhibit impact resistance, such as from high speed projectiles. Such high speed projectiles can include debris accelerated by winds, such as hurricane force winds, which can drive debris at speeds of about 50 feet per second or more. Rocks or other debris thrown from a lawnmower can be accelerated to speeds of about 200 miles per hour or more. The wind generated by the blades of a prop plane as it taxis can launch stones and debris as shrapnel. Bullets can reach speeds of 300-500 m/s or more. Shrapnel from a catastrophic failure of a lawnmower, a car engine or an airplane engine can, depending upon the distance from the door, reach speeds of about 1,000 m/s or more.

Although the door panels may become dented, the panels can minimize or prevent entry of the projectiles into the garage area. In the case of extremely high speed projectiles, even if the projectile can penetrate and breach the panel, the panel can significantly slow the projectile so that is either travels a shorter distance within the garage area or causes significantly less damage upon impact with an object within the garage.

The core of the panel can include an expanded polymeric material. For example, the core can include a polystyrene or polyurethane foam. The core can be rigid polystyrene or polyurethane foam. The core can be continuous or discontinuous. The core can have a honeycomb design (e.g., see U.S. Pat. No. 4,294,055 (Andresen, 1981) and U.S. Pat. No. 5,445,208 (Shaner et al., 1995)). The core can be affixed to and unitize the two face surfaces of the panel member to make the panel member a single unit with a rigid lightweight structure. The core can be affixed, for example, by using an adhesive that can bond the expanded polymeric material to the interior facing face surfaces of the panel member. The core provides structural stability to the panel. The core also can act as an insulator, reducing the transmission of thermal energy or sound energy or both. The core also allows the panel to be lighter than a panel of similar dimensions containing a wooden core.

The core of the panel can include a shrapnel slowing material. Examples include an aramid material or a para-aramid material, such as kevlar, boron carbide tiles, carbon fiber composite materials, ballistic nylon, ballistic fiberglass, ballistic polyethylene composite (e.g., containing an Ultra High Molecular Weight Polyethylene (UHMWPE), such as Spectra® fiber from Honeywell International Inc., Morristown, N.J.), carbon fiber with Dyneema® UHMWPE fiber (DSM Dyneema B.V., Stanely, N.C.) ceramic tiles, or a combination thereof.

The two short edge surfaces, the first horizontal long edge, the second horizontal long edge, and the face surfaces of the panels can be of the same material, or can be of different materials. Exemplary materials include steel, such as roll formed steel or sheet metal, aluminum, aluminum alloy, aluminum composite, carbon fiber, or combinations thereof. For example, each panel 10 can include a face surface of from about 20-gauge (about 0.0396 inches) to about 30-gauge (about 0.0157 inches) galvanized steel, or from about 18-gauge (0.0403 inches) to about 26-gauge (about 0.0159 inches) aluminum.

The panels can include a more lightweight exterior surface material, such as a thermoplastic resin, or resin reinforced fiberglass, or carbon-fiber-reinforced plastics, such as epoxide resin based carbon fiber-reinforced plastics, or combinations or composites thereof. Exemplary thermoplastic resins include acrylonitrile butadiene styrene copolymer (ABS), polycarbonate Acrylonitrile butadiene styrene copolymer (PC/ABS), polyether-ether-ketone (PEEK), polyetherketone ketone (PEKK), polyethylenimine (PEI), polypropylene (PP), polyphenylene sulfide (PPS), polyvinyl chloride (PVC), and thermoplastic olefin (TPO). A benefit to using plastics and resins is their light weight and the ease with which the panels can be made. The panels can be made by any desirable method, such as injection molding.

The panels can include a surface coating. The surface coating can be selected to provide damage and weather protection to the panel, such as resistance to abrasions, scratches and dents, or to improve structural integrity to the panels, or both. The surface coating can include an abrasion-resistant polymer, such as a thermoplastic elastomer, such as a thermoplastic vulcanizate (e.g., SANTOPRENE™ thermoplastic vulcanizate from ExxonMobil Corporation). The surface coating can include an aromatic polyurea/polyurethane hybrid elastomer system (e.g., Line-X® brand elastomeric protective coating). The surface coating can be applied to both sides of the panel, or only to the side of the panel facing the outside environment. The surface coating can increase the structural integrity of the panel without significantly increasing the total thickness of the panel. The surface coating can be applied to the panel by spraying, dipping, or any other form of liquid application methods.

The panel member can be manufactured in segments. For example, a first face of the panel and a second face of the panel can be separately manufactured. The first face of the panel can include edges about the perimeter of the panel. An insulating material can be applied to the first face of the panel, being contained by the edges about the perimeter of the panel. The second face of the panel then can be joined to the first face to result in a finished panel. The first and second faces of the panel can be designed so that they can be joined by press fit or snap fit, or can be joined using mechanical fastening (bolts, rivets, screws), ultrasonic welding, heat welding, inductive welding, vibration welding, solvent welding, adhesives or combinations thereof.

Any high efficiency insulating material can be included within the panel. An expanded polystyrene foam, a polyurethane foam, aerogel (such as Pyrogel® aerogel insulation, which is a silica aerogel reinforced with glass fiber) or combinations thereof can be used. In some configurations, the insulating material comprises an aerogel. A spray foam material can be combined with insulation microspheres (e.g., see U.S. Pat. No. 5,500,287 (Henderson, 1996); and U.S. Pat. No. 5,713,974 (Martin et al., 1998)) or vacuum insulated panels (VIPs) also can be included (e.g., see U.S. Pat. No. 4,726,974 (Nowobilski et al., 1988); U.S. Pat. No. 5,107,649 (Benson et al., 1992); U.S. Pat. No. 5,175,975 (Benson et al., 1993); U.S. Pat. No. 5,273,801 (Barry et al., 1993); U.S. Pat. No. 6,010,762 (Smith et al., 2000); U.S. Pat. No. 8,956,710 (Jang et al., 2015); and U.S. Pat. No. 9,523,460 (Lee et al., 2016)) or combinations thereof. By using a high efficiency insulating material, a thin, lightweight panel can be constructed that still provides sufficient insulation to prevent heat loss from the building in the winter and heat gain in the building in the summer. The insulating material can reduce the transmission of thermal energy or sound energy or both. The thermally insulating materials can be present as a single layer, or as multiple layers within the panel. Each panel can be configured to have thermal resistivity to heat loss. The panels are made of tough material with high yield strength. The panels are resistant to environmental forces such as sunlight, corrosion, moisture and humidity. The panels can have a layered composite construction, with different materials layered during fabrication of the panel. The panels can be fabricated so that the finished panel has no visible seams. The panels can be fabricated from a combination of materials that results in a lightweight panel, compared to a traditional garage door panel having a metal skin and dense foam core.

The insulating material can constitute the core of the panel. The core can have a honeycomb design (e.g., see U.S. Pat. No. 4,294,055 (Andresen, 1981) and U.S. Pat. No. 5,445,208 (Shaner et al., 1995)). The core can be affixed to and unitize the two face surfaces of the panel member to make the panel member a single unit with a rigid lightweight structure. The core can be affixed, for example, by using an adhesive that can bond the expanded polymeric material or insulating material to the interior facing face surfaces of the panel member. The core can provide structural stability to the panel. The core also allows the panel to be lighter than a panel of similar dimensions containing a wooden core.

The panel can include one or more windows. The windows can allow passage of light through the door when in the closed position, while maintaining an air-tight seal. The window can be of any transparent material. Examples include glass, acrylic and polycarbonate. The window can be constructed to have a transparent material, such as glass, present in a single layer, or a plurality of layers. In some configurations, at least two layers of transparent material are present, separated by a space. The space between the two layers of transparent material can be filled with a gas. The gas can be an inert gas, such as argon. The window material, such as glass, can be coated with one or more transparent metal oxide layers that can reflect selected wavelengths of electromagnetic radiation. In some configurations, the window material can reflect infrared electromagnetic radiation. In some configurations, the window material can reflect ultraviolet electromagnetic radiation. In some configurations, at least two transparent material layers are present, and an interlayer of polymer film is present between the two transparent material layers, forming a laminated transparent material. The polymer film can be of any polymeric material, such as polyvinylbutyral (PVB), ethylene vinyl acetate (EVA).

The window can be constructed to have a transparent material, such as glass, present in a single layer, or a plurality of layers. The panel can include privacy glass, which can turn from transparent to opaque (e.g., see U.S. Pat. No. 4,749,261 (McLaughlin et al., 1988); U.S. Pat. No. 5,408,353 (Nichols et al., 1995); U.S. Pat. No. 8,441,707 (Lam et al., 2013); U.S. Pat. No. 8,665,512 (Friedman et al., 2014); and U.S. Pat. No. 8,736,938 (Schlam et al., 2014)). Variable transparency elements can be used in the privacy glass. The privacy glass can include an electro-chromic element. In the non-transparent mode, the privacy glass can provide privacy or to reduce glare and/or heating from sunlight or other light source. The substantially transparent condition can be selected for vision through the window and to allow thermal energy to pass through to heat a space. Liquid crystal electro-active elements including polymer layers carrying the electrodes and encapsulating the liquid crystal material are commercially available and can be used in the privacy glass. The privacy glass can be used to increase security so that observers cannot see through the glass when unwanted. Functionalization of the privacy glass can be controlled through a control panel attached to a computer control module.

A panel member can have two face surfaces, a core, a first horizontal long edge containing a positive of a half-lap joint extending outwardly from the panel, and an opposite second horizontal long edge containing a negative of a half-lap joint, which can receive the positive half-lap joint of another panel. When adjacent panels are brought together upon closing the door, the extended positive half-lap joint of one panel fits into the cutaway negative half-lap joint of the adjoining panel, thereby joining the first panel to the second panel.

The recessed groove or the negative half-lap joint of the panel member can include a compressible elastomeric material. The compressible elastomeric material can be or contain rubber, vinyl, polyolefin foam, synthetic polyisoprenes, polybutadienes, polychloroprenes, chlorosulfonated polyethylenes, elastomeric polyurethanes, fluorinated elastomers, isoprene-isobutylene copolymers, ethylene-propylene-diene copolymers, styrene-isoprene-styrene block copolymers, styrene-ethylene-butylene-styrene block copolymers, and combinations thereof. When present, the compressible elastomeric material can be configured so that it does not interfere with the nesting or interfitting relationship between the tongue portion of one panel and the recessed groove or another panel, or the interfitting of the positive half-lap joint of one panel and the negative half-lap joint of another panel. When present, the compressible elastomeric material can be arranged to that it does not interfere with the ability of the respective panels to pivot or rock relative to one another. The elastomeric material can allow some movement of the interconnected panels without allowing the passage of air, dirt, dust, insects or pests through the interconnected panels. The interlocked panels exhibit substantial resistance to bending, for example, when subjected to high wind loading.

Each panel member can be independent of other panel members. Adjacent panel members can be joined together with a hinge that allows the panels to rotate about each other in an accordion fashion. One or more hinges can connect adjacent panel members. The hinge(s) can be placed and/or configured so that the adjacent panel members can be positioned so that the face surface of one panel can be adjacent to the face surface of another panel.

The face surfaces positioned toward the exterior environment or toward the interior of the building or both can include a decorative design or embossment. The embossments can be of any desired design or configuration consistent with the aesthetic appearance which is to be achieved. For example, the face surfaces can be embossed with a wood-grain pattern to simulate the appearance of wood. Because panel members are readily interchangeable, each individual panel can have the same or a different decorative design or embossment. Each panel also can have one decorative design or embossment on one side and a different decorative design or embossment on the other side. Such an arrangement can allow for an appealing visual surface on both the exterior side and interior side of the door system. This modular design allows the customer to select an aesthetic that can result in the door having a different outside appearance compared to the inside appearance. Each panel can include recessed sections, or raised sections, or combinations thereof.

In some configurations, the outermost faces can be configured to accept interchangeable covers to allow easy change the aesthetic look of the door from either side. The covers are attached using fasteners that allow the panels to be detached and changed by the customer. An exemplary fastener is a screw or snap-fit fastener. The cover can be made to have the appearance of any desired material, such as wood, granite, brick or stone.

Any one, or combination of, or all, exterior surfaces of the panel member can be coated with a coating. The coating can include a paint, a pigment, a vinyl cladding, a baked-on polyester finish, melamine, a powder coating, an anti-corrosive coating, a galvanizing coating, or any combination thereof. For example, the panel can include galvanized steel that is powder coated, or vinyl coated, or coated with baked enamel. The coating can protect the metal of the panels to provide resistance to rust, corrosion and wear, and to provide an aesthetic appearance.

Each panel can have a thickness of from about 0.5 to about 3 inches. In some applications, a panel thickness of from about 1 to about 2 inches is preferred. The length of each panel can be selected for the size of the opening to be sealed. The length of the panels can correspond to the size of any entryway, such as a residential garage. For example, the doorway opening of a typical single-car garage in the U.S. is about eight feet wide, and the doorway opening of a typical two-car garage in the U.S. is about sixteen feet wide. The panels can include an extra 0.5 to 5 inches on each end to make sure that a complete seal is formed between the closed door and the sealing member around the opening of the structure, such as a doorway of a garage. The height of the doorway opening of typical garages in the U.S. typically is seven or eight feet in height. Accordingly, for a sectional overhead garage door having four panels, each panel of a typical seven-foot four-panel door is about 21 inches tall, and each panel of a typical eight-foot four-panel door is about 24 inches tall.

A plurality of panels form a door. Typically, from 4 to 8 panels can be interconnected to form the door, depending on the height of the opening in the structure to be closed be the door, and the height of each panel forming the door. In exemplary configurations, 4 to 8 horizontally disposed panels make up a door. When in the closed position, the panels can be stacked in a vertical orientation or a one atop another in a horizontal position. When opened, the panels of the door clear the doorway opening, providing access to the interior of the structure, such as a garage.

The panels are contained in the moveable frame. The frame typically is larger than the doorway opening so that when the frame advances to have the panels engage with the sealing member around the doorway opening, the panels of the door come into contact with a sealing member attached to the doorway opening and the frame does not interfere with the engagement of the panels with the sealing member.

The sealing member can include any compressible material that is reversibly deformable and conforms in shape to the surface of an object brought into contact with the sealing member. The sealing member typically includes an elastomeric compressible material. The compressible elastomeric material can be or contain rubber, vinyl, polyolefin foam, synthetic polyisoprenes, polybutadienes, polychloroprenes, chlorosulfonated polyethylenes, elastomeric polyurethanes, fluorinated elastomers, isoprene-isobutylene copolymers, ethylene-propylene-diene copolymers, styrene-isoprene-styrene block copolymers, styrene-ethylene-butylene-styrene block copolymers, and combinations thereof. The sealing member can include sponge rubber. The sealing member can include a flexible strip of plastic resins. The sealing member can be hollow. The sealing member can be a resilient semi-circular strip of elastomeric compressible material. The sealing member can include a foamed plastic, such as a closed-cell polyethylene foam. The sealing member can include a horizontally disposed elastomeric reservoir containing a quantity of fluid secured to a header above the doorway opening and spaced tubular elastomeric members secured at each side of the doorway opening of the building structure, where fluid forced into the tubular members extend them into sealing contact with the side edges of the panels of the door (see U.S. Pat. No. 4,250,941 (McNally, 1981)).

The cross-section of the sealing member can be of any shape, with a circular or semi-circular shape being typical. When the sealing member has a solid (filled) circular cross-section, the sealing member has the shape of a solid cylinder or rod. The sealing member can have a hollow aperture formed in the interior of the sealing member that extends the length of the material. When this aperture interior is cylindrical in shape it typically results in a sealing member with an annular cross-section, that is, the sealing member is in tubular form, i.e., in the shape of an annular cylinder. The sealing member should have sufficient resiliency and compressibility to return to its original shape after the application of compression forces, e.g., when the frame engages the panels with the sealing member.

The sealing member can be attached to the top and side edges of the doorway opening using any appropriate fasteners. Typical fasteners include screws, nails, clips, clamps and adhesives, such as glue or epoxy. A sealing member or weather seal also can be fastened along the bottom edge of the bottom-most panel. The sealing member can be compressible and forms a seal when the door is moved into the closed position. Two or more panels of the door can be connected by a pivot point, such as a hinge.

Any door operating mechanism to open and close the door can be included in the systems provided herein. A variety of operating mechanisms have been disclosed and used in the past for opening garage and warehouse doors (e.g., see U.S. Pat. No. 4,102,382 (Vesbach, 1978); U.S. Pat. No. 4,188,552 (Brimer, 1980); U.S. Pat. No. 4,794,731 (Willmott et al., 1989); U.S. Pat. No. 5,040,332 (Aquilina, 1991); U.S. Pat. No. 5,221,869 (Williams et al., 1993); U.S. Pat. No. 5,841,253 (Fitzgibbon et al., 1998); U.S. Pat. No. 5,918,418 (Richmond et al., 1999); U.S. Pat. No. 5,927,690 (White et al., 1999); U.S. Pat. No. 5,931,212 (Mullet et al., 1999); U.S. Pat. No. 5,937,579 (Baczewski et al, 1999); U.S. Pat. No. 6,401,792 (Mullet et al., 2002); U.S. Pat. No. 7,543,410 (Baczewski et al., 2009); U.S. Pat. No. 7,537,042 (Altimore, 2009); and U.S. Pat. No. 9,273,508 (Manaras, 2016)). The door operating mechanism can include a mechanical opener, an electromechanical opener, an electrical opener, a hydraulic opener, a pneumatic opener or combinations thereof.

The door operating mechanism can include an electric motor and a screw-driven lift arm. The door operating mechanism can include a screw or chain driven lifting mechanism in combination with a torsion spring counterbalance system. An electric motor can be connected to the screw or chain lifting mechanism. The door operating mechanism can include hydraulic or pneumatic cylinders connected to a suitable fluid storage tank as a lifting mechanism. The door operating mechanism can include combinations of springs and hydraulic and pneumatic systems, or combinations of spreading cables and hydraulic systems. The door operating mechanism can include a carriage assembly connected to at least one panel of the door and a flexible drive cable, belt or chain that when activated moves the carriage to open and close the door. The door operating mechanism can include a rotatable motor driven member mounted on the frame, which motor driven member drives a first cable, belt or chain; a rotatable shaft having opposed ends mounting the driven member for rotation at one of the ends of the shaft, the shaft being mounted in at least one bearing device mounted on the frame; a rotatable drive member mounted at the other of the ends of the shaft; a second flexible cable, belt or chain mounted on the rotatable drive member which when activated rotates the shaft and driven member; and an electric drive motor member rotatably mounted on the other of the ends of the frame and connected to the second flexible cable, belt or chain, where when the drive motor is activated it moves the second flexible cable, belt or chain, rotates the drive member, shaft and driven member to move the first flexible cable, belt or chain and the carriage assembly to open and close the door. The drive and driven members can be bicycle-type sprockets mounted on the drive shaft and bicycle-type chains that engage the sprockets.

The door operating mechanism can include a shaft with a pair of spaced apart helical or non-helical or side drums mounted on the shaft, and a cable, belt or chain connecting each helical or non-helical or side drum to the bottom panel of door. A cable drum can be mounted proximate to each end of the shaft and outside of the side drums. A bearing plate can be used to separate each side drum from the respective cable drum. The door operating mechanism can include a standard electric door motor, screw or lift-arm connected to the upper panel of the door. It will be understood by those skilled in the art that it is not necessary for the door operating mechanism to be powered by a motor in order to operate, the door can be raised and lowered by any other suitable mechanism, including a hydraulic opener or a pneumatic opener. The drums can be installed on the shaft by any suitable mechanism, such as threaded bolts or screws that are screwed inwardly until they engage and lock the drums onto the shaft. This allows the drums to rotate with the shaft. The drums and shaft can be manufactured from steel or aluminum or any other suitable material or alloy. It will be understood by those skilled in the art, that it is not necessary to utilize a shaft that extends across the entire width of the doorway opening of the structure. It is possible to use two smaller separate shafts to operatively connect each side drum with its respective cable drum.

The door operating mechanism can include an electric motor, a chain drive mechanism and a length of a bicycle-type chain geared to the chain drive mechanism driven by the electric motor. An end of this length of bicycle-type chain, as a first chain, can be mounted around a drive sprocket mounted on a shaft. The shaft can be a length of round steel bar with the drive sprocket and a driven sprocket mounted on each of the ends. The shaft can be of a length to fit the installation space parameters vertically, and typically is mounted perpendicular to the first chain. The shaft can be mounted above or rearward of the garage doorway opening and garage door. A length of a similar bicycle-type chain, as a second chain, can be fitted to the driven sprocket at the other end of the shaft and movement and travel of the second chain can be guided by a traverse rail, forwardly directed towards the top of the garage door. Extending from the end of this second chain can be a length of cable that is attached to the top-most panel of the garage door. The cable can be attached through a hinged bracket. The door operating mechanism can include a worm drive shaft. The door operating mechanism can include a support platform, a track, a drive chain, and an electrically operated bidirectional drive system.

The door operating mechanism can include a pair of actuator arms that can lift and stack the panel members of the door into a stack to open the door, and that can place the panels into the track of the door system frame when the door is to be closed. The actuator arms can be mechanical or robotic arms. The actuator arms can include a clamp or fingers at their distal ends to engage with the panel so that the arms can move the panel from one orientation to another and from one location to another. The actuator arms can be connected to a drive shaft or drive mechanism (e.g., hydraulic or pneumatic or electric) to power the actuator arms. Actuator arms that can lift and move an object are known in the art (e.g., see U.S. Pat. No. 3,935,950 (Burch, 1976); U.S. Pat. No. 4,264,266 (Treschsel, 1981); U.S. Pat. No. 4,298,441 (Inaba et al., 1981); U.S. Pat. No. 4,514,136 (Abe, 1985); U.S. Pat. No. 4,541,770 (Niiniomi et al., 1985); U.S. Pat. No. 4,687,100 (Lichti, 1987); U.S. Pat. No. 6,474,047 (Grams et al., 2002); and international patent application publication WO 2003/078111 A1 (Smede et al, 2003)). The actuator arms can be mounted on a rail system or a track system.

In some configurations, the panels of the door are independent of each other and not connected to each other. A door operating mechanism lifts the door from the bottom panel, advancing the door panels to the top of the track. As the uppermost panel reaches the top of the track, the actuator arms grasp the panel, removing it from the track and placing it on the landing portion. As the door operating mechanism continues to advance the door panels to the top of the track, the actuator arm releases the first uppermost panel on the landing portion, and moves to grasp the next panel that is at the top of the track, removing it from the track and placing it on the landing portion next to or on top of the first panel, stacking the panels. The panels can be stacked horizontally or vertically in a compact stack. This procedure is repeated until all of the panels except the last panel have been removed from the track.

To close the door, the door operating mechanism is reversed, pulling the bottom-most panel downward in the track. The actuator arm grasps a panel form the stack and places it into the track. Once in the track, gravity moves the panel downward until its tongue portion engages with the recessed groove of the panel beneath it. This process is repeated until all panels have been returned to the track. The movable connector then is activated to move the panels of the door against the sealing member to close and seal the doorway opening.

Any door operating mechanism can be used. For example, the door operating mechanism can include a worm drive shaft, a mechanical opener, an electromechanical opener, an electrical opener, a hydraulic opener, a pneumatic opener or combinations thereof. The door operating mechanism can include an electric motor and a screw-driven lift arm, or a screw or chain driven lifting mechanism, or an electric motor connected to a screw or chain lifting mechanism, or hydraulic or pneumatic cylinders, or bicycle-type sprockets mounted on the drive shaft and bicycle-type chains that engage the sprockets.

The door operating mechanism can be mounted on the ceiling area of the garage, or on a side wall on beams or supports, or installed on mounts at a height equal to the height of the garage door in its raised position. The entire mechanism can be configured to be parallel to the garage floor in its fully installed position. The door operating mechanism can be configured so that its cable or chains are perpendicular to the garage floor and parallel to the tracks of the door system frame.

The system also can include a weather seal attached to the tongue portion of the bottom-most panel. The weather seal conforms to the floor of the building structure, such as a garage, and can accommodate horizontal movement as the door system frame is moved toward or away from the doorway opening. When the door is in the closed position, the weather seal can form an airtight seal between the lower door panel and the floor of the doorway opening. The weather seal can be of any elastomeric material. The weather seal 22 can be or contain rubber, polyolefin foam, vinyl, synthetic poly-isoprenes, polybutadienes, polychloroprenes, chlorosulfonated polyethylenes, elastomeric polyurethanes, fluorinated elastomers, isoprene-isobutylene copolymers, ethylene-propylene-diene copolymers, styrene-isoprene-styrene block copolymers, styrene-ethylene-butylene-styrene block copolymers, and combinations thereof. Any weather seal known in the art can be used (e.g., see U.S. Pat. No. 4,525,953 (Stutzman, 1985); U.S. Pat. No. 5,092,079 (Brookman et al., 1992); and U.S. Pat. No. 6,140,380 (Mauk et al., 2000)).

To mitigate noise during operation, one or more acoustic dampers or acoustic dissipaters can be included. For example, each panel can include an acoustic damper within the panel. The acoustic damper can be the insulating material, or in addition to the insulating material. A viscoelastic polymer can be used as a layer within the composite panel to act as an acoustic damper or dissipater. Examples include mass-loaded vinyl, nitrile rubber, rubber-modified epoxy resin, carboxy-terminated butadiene nitrile, and butadiene-acrylonitrile copolymer rubber. Similar materials can be used to acoustically insulate the box housing the motor(s). Low-noise motors also can be used to mitigate a major source of the noise generated during opening and closing of the door. In some configurations, a toothed non-metal belt is used for vertical actuation instead of a screw or chain to reduce noise. To minimize vibration-generated noise, some configurations minimize the use of metal parts.

The door system can be manufactured and sold as a single unit. All components of the door system, regardless of the design, can be prepackaged, and where appropriate, incorporated into the frame. The frame can easily installed about the building opening.

The door systems provided herein can include additional elements. In some configurations, the door system can include a computer module for partial or complete automation of the system. The computer module can include a computer in communication with and/or in control of any part of the door system. The computer module can communicate with a control system to automate or operate the opening and closing of the door. The control panel can be configured to operate lights, mechanical components, operating mechanisms, a touch panel, and automatic closing and locking mechanisms. In the systems provided herein, the computer module can include a non-transitory computer-readable storage medium having a computer-readable program embodied therein for directing operation of the door system and/or any component of the system.

The door system also can include one or more sensors. Exemplary sensors include infrared tripping sensors, variable resistance sensors, thermocouples, carbon monoxide detectors, and smoke detectors. The system also can include monitors for airborne contaminates, such as dust or particulate matter and natural gas. Sensors can be connected to the sealing element, and can alert the computer module when the sealing element needs to be cleaned in order to keep it air tight. Timers can be included to measure the time the door is in the open position, and can be in communication with the control panel, which can send a signal to notify the homeowner (such as by sending a text or calling a cellular phone) or trip an alarm if the door has been left in the open position for an extended period of time, especially at night. The door system also can be configured so that after a certain amount of time has expired, the garage door can automatically close as long as nothing is obstructing the pathway of the doors.

Visual or auditory alarms or combinations thereof can be attached to or in communication with the sensors, and activate if any detectors or sensors are tripped. Smart audio speakers with Bluetooth capability can allow wireless placement of the speakers anywhere within the garage to sound alarms.

The system can be configured to include sensors that can detect movement, such as to determine the difference between a car entering or exiting the opening, or a static object in the path of the door system. The system can provide visual warnings in response to the detection. For example, an LED lighting system can be configured to light up or and remain lit at one wavelength, e.g., emitting an orange light, when a car is slowly moving through the opening within the closing zone of the door system. Once the car has made it through the closing zone of the door system, the LED lights emit light of a different color, such as green, signaling that it is safe for the door to close. If a static object is in the closing path of the door system, the lights can be configured to emit light of a different color, such as red, signifying that the user must clear the doorway of the object obstructing the path of the doors in order for the door system to close the doors. Similar auditory “alarms” or signals are available in current technologies, but visual sensors can elicit a stronger response in humans than auditory alarms, creating a more effective manner of communication between the door and the user.

Instead of, or in addition to, visual signals, auditory alarms also can be included in the system. Different auditory signals can be used for each sensor, resulting in different auditory responses for a smoke alarm than a carbon monoxide indicator. The door system can be configured to include voice technology systems as auditory alarms, such as to warn users of obstructions in the door path, of increased carbon monoxide levels, or the detection of smoke in the garage. The door system can be configured so that a user can customize a variety of alarm noises to be associated with different sensors. All alarm sensors and triggers can be designed to be in accord with CFR standards.

The control system can be in communication with the sensors, and work in conjunction with the sensors. The control system can be navigated by use of a touch panel in communication with the computer module. The control panel can include a color-coded light indicating system to indicate the status of the system, and the position of the door, and the status of one or more of the sensors. For example, the lighting system can include a blinking function the is green, yellow, or red depending on the readiness for the system to close the door. The computer module also can record usage history information, such as for safety or security reasons.

The control panel can be located within the building. The control panel automatically can synchronize with the computer module to control the door system operational parameters. The control panel can include a screen that can display the status of the system and any attached sensors. The screen also can be configured to display indoor temperature and relative humidity, and outdoor weather characteristics, such as wind speed, relative humidity, temperature, and barometric pressure. The control panel can include touch screen with a NEMA 4 enclosure type, and be configured to prevent ingress of moisture, dirt, or air. The system frame can be configured to house the control panel. Multiple control panels can be configured to work with the system, allowing remote access and control or observation of the system. The system can be configured so that a user can open, lock, and switch between electronic and manual use of the door, and can do so remotely using a cellular phone. The system also can be configured to include voice recognition software to allow operation via voice command. By integrating the voice recognition software with control panel, voice commands can be used for all electronic functions of the system.

The garage door can be configured to include a smart system that allows for user customizability. The smart system can connect the door system provided herein to smart house products such as AMAZON ECHO and GOOGLE HOME. In addition, it can be configured to have user specific opening codes, or configured to be interactive with a cellular phone application. The door system can be configured to that its smart system can connect to a Wi-Fi, such as for communication with a cellular phone application, or to receive software updates. The system also can be configured to send a notification to the manufacturer of any equipment failure or malfunction to allow for automatic contacting of servicing personnel, or to alert a homeowner of the malfunction. The computer module can be configured to allows easy update of hardware.

The door system can include an alternate power option, such as backup power generator, solar panels, or battery system, that can be used in case of interruption of utility services. The door system can include a ventilation system that can move air out of the garage or enclosed space or introduce fresh air into the garage or enclosed space. This can allow the door system to monitor and modulate the climate within the garage. The ventilation system can include a filtered fan or blower, which allows air movement but prevents particulate matter from being introduced into the garage by the fan or blower. The ventilation system can include an air freshening component to keep the garage space smelling fresh. The door system can include a dehumidifier. The door system can include an air conditioning unit to dehumidify and modulate the temperature within the garage.

The door system frame can be configured to include a blower system. For example, the door system frame can be configured to contain a piping system attached to an air blower. Holes in the piping system, alone or in combination with the ability to rotate the pipe of the piping system to reposition the orientation of the holes with respect to the system, can be used to blow air to move dust, leaves, and moisture away from the door, or from a car passing through the building opening. When raining, the blower can be activated to help prevent excess water from entering the garage.

The doorway opening of the building to which the door system provided herein is to be attached includes a compressible elastomeric material along the length of the horizontal header and each of the vertical beams located at either end of the doorway opening and defining the doorway opening of the building. The compressible elastomeric material can be of any elastomeric material. The compressible elastomeric material can be or contain rubber, polyolefin foam, vinyl, synthetic polyisoprenes, polybutadienes, polychloroprenes, chlorosulfonated polyethylenes, elastomeric polyurethanes, fluorinated elastomers, isoprene-isobutylene copolymers, ethyl ene-propylene-diene copolymers, styrene-isoprene-styrene block copolymers, styrene-ethylene-butylene-styrene block copolymers, and combinations thereof. The elastomeric material is of a dimension sufficient to engage with the door when the frame is moved toward the doorway opening. For example, the compressible elastomeric material can have a height of from about 0.5 to about 2.5 inches. The compressible elastomeric material can have a height of from about 0.5 to about 2.5 inches. When the door is in position and ready to be closed, the movable connector repositions the door system frame toward the doorway opening. As the door system frame approaches the doorway opening, the panels of the door come into contact with the compressible elastomeric material outlining the doorway opening, deforming the compressible elastomeric material so that an airtight seal is formed between the panels of the door and the compressible elastomeric material outlining the doorway opening.

A control circuit for opening and closing the door can be a manually operated switch or a radio receiver-type switch and related circuitry, as are well known to those skilled in the art. When the door is in the closed position and the control circuit is activated, the movable connector is activated and moves in one direction to reposition the door system frame away from the doorway opening. When the door frame system has been repositioned away from the doorway opening, a motor of the door operating mechanism can be energized to drive a belt that moves the door panels upward to open the doorway.

The control circuit also can include obstruction sensing circuitry to stop the closing of the door if an obstruction is detected that would prohibit closing of the door. Such circuits are conventional and their detailed description is not provided.

In case of a power failure, the system can include a back-up power supply. The back-up power supply can include a battery to energize the movable connector to move the door frame system away from the doorway opening and to energize a motor to move the door panels upward to place the door in the open position. The door system also can be operated manually.

The door system provided herein can produce less noise when moving the door into an open or closed position than produced by traditional garage doors. Quiet motors, such as stepper motors and conventional DC motors driven by a power control signal can be selected that result in the product of little noise, resulting in quiet operation of the door system. Use of composite panels rather than metal panels also allow for the door to be very light, obviating any need for a door tension spring used in many conventional overhead garage doors, further reducing operating noise. The actuator of the door system that places the door panels in a stacked vertical or horizontal position for storage can include rollers and noise dampening material to further produce a quiet operating door system. The storage of the door as collapsed panels above the garage door opening allows for better utilization of garage storage, freeing up a significant amount of square footage in the ceiling area normally occupied by the door in traditional garage door systems. The airtight seal produced by the door system prevents entry of wind, rain, insects, pests and vermin into the garage. The door system thus promotes energy efficiency and cleanliness of the garage.

Many different types of motive power are capable of use for opening and closing the door of the systems provided herein, and the provided systems are not limited to a particular device or manner so capable. A mechanical, electromechanical, electrical, hydraulic, or pneumatic system can be provided to supply motive power to drive the opening and closing of the door. When an electro-mechanical system is used, it not limited in the manner in which the electro-mechanical system receives electrical power. For example, the electro-mechanical system can receive electrical power from a remotely located solar panel, or a battery located locally or remotely, or electrical power from line voltage via the structure in which the door system is installed.

Exemplary embodiments are described below in conjunction with the accompanying figures. The following description is only illustrative and should not be viewed as limiting.

An exemplary door frame system is illustrated in FIGS. 1A and 1B. FIG. 1A is a side view of the system in a state where the door is ready to be opened. FIG. 1B is a side view of the system in a closed state. As can be seen in FIG. 1A, when the door is to be opened, the upper movable connector 600 and lower movable connector 650 move the vertical side 115 of the door system frame away from the building opening sealing element 500 and upward toward the interior ceiling of the building, such as the ceiling of a garage. This results in the panels of the door disengaging with the opening sealing element 500 and moving the door frame system towards the interior of the building. The action of the upper movable connector 600 and lower movable connector 650 also results in door system frame being lifted upward so that the weather seal at the bottom of the bottom-most panel is lifted up from the floor of the garage, minimizing wear to the weather seal as the door opens and closes.

When the door is to be closed, the panels of the door are extended from the storage location above the building opening, such as from the landing portion 130, and are lowered downward vertically to traverse across the building opening. Once the panels have been fully extended effectively closing the building opening, the upper movable connector 600 and lower movable connector 650 are activated in the opposite direction, moving the door system frame towards the building opening and downward toward to floor. The action of the movable connectors 600 and 650 on the vertical side of the door system frame results in the door system frame moving towards the building opening, and the panels of the door engage firmly with the opening sealing element 500, securely fitting the panels of the door against the opening sealing element 500 to form an airtight seal.

The frame can be moveably connected to the doorway opening using a plurality of movable connectors 550. In some configurations, a building vertical beam 525 on each side of the doorway opening 400 can include a first movable connector 600 near the bottom and a second movable connector 650 near the top of the opening. An exemplary configuration is shown in FIGS. 1A and 1B.

In some configurations, a building vertical beam 525 on each side of the doorway opening can include a movable connector 550 positioned halfway, three-quarters, 90%, or any value between at or about 50% to at or about 95% of the distance from the bottom of the vertical beam to the top of the vertical beam, and a pivot joint 575 near the bottom of the vertical beam, such as at the lower-most position of the beam, or from 10%-30% of the total length of the beam from the bottom of the beam. An exemplary configuration is shown in FIGS. 1C and 1D. FIG. 1C is a side view of the system in a state where the door is ready to be opened. FIG. 1D is a side view of the system in a closed state.

As can be seen in FIG. 1C, when the door is to be opened, the movable connector 550 pushes the vertical side 115 of the door system frame away from the building opening sealing element 500 and upward toward the interior ceiling of the building, such as the ceiling of a garage, rotating on the pivot joint 575. This results in the panels of the door disengaging with the opening sealing element 500 and moving the door frame system towards the interior of the building. The action of the movable connector 550 and the pivot joint 575 also results in door system frame being lifted upward so that the weather seal at the bottom of the bottom-most panel is lifted up from the floor of the garage, minimizing wear to the weather seal as the door opens and closes.

When the door is to be closed, the panels of the door are extended from the storage location above the building opening, such as from the landing portion 130, and are lowered downward vertically to traverse across the building opening. Once the panels have been fully extended effectively closing the building opening, the movable connector 550 on each side of the door opening are activated in the opposite direction, pulling the door system frame towards the building opening and downward toward to floor. The action of the movable connectors 550 on the vertical side of the door system frame results in the door system frame moving towards the building opening, and the panels of the door engage firmly with the opening sealing element 500, securely fitting the panels of the door against the opening sealing element 500 to form an airtight seal. The action of the movable connectors 550 in connection with the pivot joint 575 results in a zipper-type closure of the opening sealing element 500 against the panels of the door. For example, as the door is opened, the movable connectors 550 push the door system frame away from the opening sealing element 500, disengaging the opening sealing element 500 from the door panels from the top of the door system frame to the bottom, as the pivot joint 575 positions the vertical side 115 of the door system frame away from the opening. The zipper-like closure is reversed upon closing of the door, as the movable connectors 550 pull the door system frame toward from the opening sealing element 500, engaging the opening sealing element 500 with the door panels from the bottom of the door system frame to the top.

The pivot joint 575 can be any joint configuration that allows operation of the door as described above. For example, the pivot joint can include a swivel, a swivel flange, a swivel socket, a hinge, a ball and socket connector, an L-shape ball joint, an extender rod, a spring-loaded rod, a spring-tension rod, a spherical rod end, a spherical joint, or a combination thereof. The pivot joint can be a flexible or rigid connector between the vertical side 115 of the door system frame and a building vertical beam 525, that allows rotation of the door system frame about the connector as the vertical side 115 of the door system frame is pushed away from or pulled toward the opening sealing element 500.

The movable connector 550 can include a combination of motor driven threaded member connected to corresponding receiving member. The motor driven threaded members can be attached to the vertical sides 115 and the corresponding receiving members can be attached to elements of the doorway opening, such as a joist or stud. Conversely, the motor driven threaded members can be attached to elements of the doorway opening, and the corresponding receiving members can be attached to the vertical sides 115 of the frame. For example, a plurality of metal plates can be fixedly attached to the doorway opening. A metal plate can be located on the interior of the building attached to each vertical beam. In some configurations, each vertical beam of the doorway opening includes two metal plates spaced apart. In some configurations, each vertical beam on either side of the doorway opening can include a metal plate near the top of the doorway opening positioned to be connectable to the vertical side 115.

Each metal plate can include an internally threaded opening. A threaded member that is engaged with the internally threaded opening in the plate attached to the building is attached to the vertical side 115. A motor is attached to the threaded member and when energized can cause the threaded member to rotate. The motor can be in communication with the control panel, which can control the movement of the threaded member. The control panel can control the amount and the direction that the threaded member is rotated by motor. The threaded member can be a screw or bolt. Rotation of the threaded member by the motor in one direction repositions the vertical side 115 toward the doorway opening, and rotation of the threaded member by the motor in the opposite direction repositions the vertical side 115 away from the doorway opening. For example, rotation of the threaded member by the motor clockwise can reposition the vertical side 115 toward the doorway opening, and rotation of the threaded member by the motor counterclockwise can reposition the vertical side 115 away from the doorway opening.

Alternatively, rotation of the threaded member by the motor counterclockwise can reposition the vertical side 115 toward the doorway opening, and rotation of the threaded member by the motor clockwise can reposition the vertical side 115 away from the doorway opening. The motor can be in communication with the computer module, which can include a program to drive the speed and direction of the motor. The control panel can be configured to communicate with the computer module to modulate the power provided to the motor, or regulate the speed and direction and duration of movement of the motor, or permit automatic activation of the motor in response to a signal, or any combination thereof. The invention is not tied to any specific motor or type of motive device.

The threaded member can be a screw or bolt or similar fastener having a screw thread that can engage with the internally threaded opening in metal plate attached to the vertical supports of the door frame. The internally threaded opening can receive the threaded member. The motor can be attached to the frame. The threaded member attached to the frame motor can engage the internally threaded opening in the metal plate to form a threaded engagement between the vertical side 115 and the doorway opening by which the vertical side 115 moves closer to or further from the doorway opening in response to the rotation of the motor-driven threaded member. A movable sleeve that can extend and retract can be included to shield and protect the threaded member.

The motor can be a conventional direct-current (DC) motor driven by a power control signal, or can be a stepper motor that allows a precise amount of rotation of the threaded member by electronically controlling the number of energizing pulses supplied to the motor. The motor can operate to rotate in the forward and reverse directions. A control circuit can be programmed to control rotation of the motor in the forward and reverse directions in response to an indication that the door is to be opened or closed. The motor can include an electronic control unit in communication with the motor that can be programmed to stop rotation of the motor virtually instantaneously once the vertical side 115 has been moved sufficiently toward to doorway opening to seal the doorway opening.

The movable connectors 600 and 650 can include an electro-mechanical connector, an electric-hydraulic connector, a hydraulic connector, a pneumatic connector, an electro-pneumatic connector, a solenoid valve connector, a mechanical spring connector, or a combination thereof.

Exemplary door panel configurations are illustrated in FIGS. 2A-2D and 2F-2I. In the exemplary configurations shown in FIGS. 2A-2D, a recessed groove 15 is located at a top portion of a panel relative to the ground, and a tongue portion 17 of an upper panel is accepted into the recessed groove 15 of a lower panel. In the exemplary configurations shown in FIGS. 2F-2I, the relative positions of the tongue and groove are reversed, with a recessed groove 15 of an upper panel accepting the tongue portion 17 of a lower panel.

As illustrated in FIG. 2A, a panel 10 has two face surfaces 11 and 12, a core 13, first horizontal long edge 14 containing a recessed groove 15, and an opposite second horizontal long edge 16 containing a tongue portion 17. The recessed groove 15 can include along its sides a compressible elastomeric material 20. The recessed groove 15 can include along the bottom of the groove a compressible elastomeric material 21. In some configurations, the recessed groove 15 can include along its sides a compressible elastomeric material 20 and along the bottom of the groove a compressible elastomeric material 21. The compressible elastomeric material can be or contain rubber, vinyl, polyolefin foam, synthetic polyisoprenes, polybutadienes, polychloroprenes, chlorosulfonated polyethylenes, elastomeric polyurethanes, fluorinated elastomers, isoprene-isobutylene copolymers, ethyl ene-propylene-diene copolymers, styrene-isoprene-styrene block copolymers, styrene-ethylene-butylene-styrene block copolymers, and combinations thereof. When present, the compressible elastomeric material 21 is configured so that it does not interfere with the nesting or interfitting relationship between the tongue portion 17 and the recessed groove 15. When present, the compressible elastomeric material should not interfere with the ability of the respective panels to pivot or rock relative to one another, as is typically necessary in connection with sectional garage doors. The elastomeric material can allow some movement of the interconnected panels without allowing the passage of air, dirt, duct, insects or pests through the interconnected panels. The panel also includes two short edge surfaces 18 and 19 (see FIG. 2B).

The recessed groove 15 is designed and positioned along the first horizontal long edge 14 so that is it sufficiently deep relative to the tongue portion of a second panel to receive the tongue portion of the second panel and thereby join the first panel to the second panel. As shown in FIG. 2A, tongue portion 17 of panel B is configured and positioned to be received by groove 15′ of panel A. The tongue portion and the recessed groove can act as a tenon and mortise, respectively. Although the figure depicts the tongue portion and the recessed groove to have a rectangular shape, any appropriate shape can be used. Exemplary shapes include a rectangular open mortise (having only three sides, as depicted in FIG. 2A), a tapered mortise (having a tapered shape that is wider at the top (near horizontal long edge 14) and narrower at the bottom (near the core 13) as illustrated in FIG. 2C), and a curved bottom open mortise having a rounded bottom or U-shape (as illustrated in 1D). When viewed from the front, panel A can be joined to panel B by inserting tongue portion 17 of panel B into recessed groove 15′ of panel A. The intermeshing of the tongue and groove of the two panels bridges sheer forces and tensile forces between the core panels across the intermeshing joint as well as torsional stress. The intermeshing of the tongue and groove also stabilizes the panels relative to each other. The interlocked panels exhibit substantial resistance to bending, for example, when subjected to high wind loading.

The tongue portion 17 can include a metal insert 25. Metal insert 25 can run the full horizontal length of panel B in tongue portion 17. Metal insert 25 can be rod or a sheet. Metal insert 25 can be a length of corrugated steel sheet, such as illustrated in FIG. 2E. As shown in the figure, sides 17a and 17b forming the tongue portion 17 and a corrugated metal insert 25 is placed within the tongue portion 17. Metal insert 25 can have a dimension such that it occupies only a portion of the full width of tongue portion 17. Metal insert 25 can have a dimension such that it occupies substantially the full width of tongue portion 17. The metal insert 25 can be fixed in tongue portion 17. It can be fixed by fastening using staples, screws, nails, adhesive such as glue or any combination thereof. The metal insert 25 can be embedded in the same material as core 13.

The core of the panel (shown as 13 in FIG. 2A) can include an expanded polymeric material. For example, the core can include a polystyrene or polyurethane foam. The core can be rigid polystyrene or polyurethane foam. The core can be continuous or discontinuous. The core can have a honeycomb design (e.g., see U.S. Pat. No. 4,294,055 (Andresen, 1981) and U.S. Pat. No. 5,445,208 (Shaner et al., 1995)). The core can contain aerogel (such as Pyrogel® aerogel insulation, which is a silica aerogel reinforced with glass fiber) or insulation microspheres or vacuum insulated panels or combinations thereof. The core can be affixed to and unitize the two face surfaces 11 and 12 to make the panel a single unit with a rigid lightweight structure. The core can be affixed, for example, by using an adhesive that can bond the expanded polymeric material to the interior facing face surfaces.

The two short edge surfaces 18 and 19, the first horizontal long edge 14, the second horizontal long edge 16, and the face surfaces 11 and 12 can be of the same material, or can be of different materials. Exemplary materials include steel, such as roll formed steel or sheet metal, aluminum, aluminum alloy, aluminum composite or combinations thereof. For example, each panel 10 can include a face surface of from about 20-gauge (about 0.0396 inches or 0.912 mm) to about 30-gauge (about 0.0157 inches or 0.305 mm) galvanized steel, or from about 18-gauge (0.0403 inches or 1.214 mm) to about 26-gauge (about 0.0159 inches or 0.455 mm) aluminum.

As illustrated in FIG. 2F, a panel has two face surfaces 11 and 12, a core 13, a first horizontal long edge 14 containing a recessed groove 15, and an opposite second horizontal long edge 16 containing a tongue portion 17. The recessed groove 15 can include along its sides a compressible elastomeric material 20. The recessed groove 15 can include along the bottom of the groove a compressible elastomeric material 21. In some configurations, the recessed groove 15 can include along its sides a compressible elastomeric material 20 and along the bottom of the groove a compressible elastomeric material 21. The compressible elastomeric material can be or contain rubber, vinyl, polyolefin foam, synthetic polyisoprenes, polybutadienes, polychloroprenes, chlorosulfonated polyethylenes, elastomeric polyurethanes, fluorinated elastomers, isoprene-isobutylene copolymers, ethylene-propylene-diene copolymers, styrene-isoprene-styrene block copolymers, styrene-ethylene-butylene-styrene block copolymers, and combinations thereof. When present, the compressible elastomeric material 21 is configured so that it does not interfere with the nesting or interfitting relationship between the tongue portion 17 and the recessed groove 15. When present, the compressible elastomeric material should not interfere with the ability of the respective panels to pivot or rock relative to one another, as is typically necessary in connection with sectional garage doors. The elastomeric material can allow some movement of the interconnected panels without allowing the passage of air, dirt, duct, insects or pests through the interconnected panels. The panel also includes two short edge surfaces 18 and 19 (see FIG. 2G).

The recessed groove 15 is designed and positioned along the first horizontal long edge 14 so that is it sufficiently deep relative to the tongue portion of a second panel to receive the tongue portion of the second panel and thereby join the first panel to the second panel. As shown in FIG. 2F, groove portion 15 of panel B is configured and positioned to receive tongue portion 17′ of panel A. The tongue portion and the recessed groove can act as a tenon and mortise, respectively. Although the figure depicts the tongue portion and the recessed groove to have a rectangular shape, any appropriate shape can be used. Exemplary shapes include a rectangular open mortise (having only three sides, as depicted in FIG. 2F), a tapered mortise (having a tapered shape that is wider at the top (near horizontal long edge 14) and narrower at the bottom (near the core 13) as illustrated in FIG. 2H), and a curved bottom open mortise having a rounded bottom or U-shape (as illustrated in 21). When viewed from the front, panel A can be joined to panel B by inserting tongue portion 17′ of panel A into recessed groove 15 of panel B. The intermeshing of the tongue and groove of the two panels bridges sheer forces and tensile forces between the core panels across the intermeshing joint as well as torsional stress. The intermeshing of the tongue and groove also stabilizes the panels relative to each other. The interlocked panels exhibit substantial resistance to bending, for example, when subjected to high wind loading.

The core of the panel (shown as 13 in FIGS. 2A and 2F) can include an expanded polymeric material. For example, the core can include a polystyrene or polyurethane foam. The core can be rigid polystyrene or polyurethane foam. The core can be continuous or discontinuous. The core can have a honeycomb design (e.g., see U.S. Pat. No. 4,294,055 (Andresen, 1981) and U.S. Pat. No. 5,445,208 (Shaner et al., 1995)). The core can contain aerogel (such as Pyrogel® aerogel insulation, which is a silica aerogel reinforced with glass fiber) or insulation microspheres or vacuum insulated panels or combinations thereof. The core can be affixed to and unitize the two face surfaces 11 and 12 to make the panel a single unit with a rigid lightweight structure. The core can be affixed, for example, by using an adhesive that can bond the expanded polymeric material to the interior facing face surfaces.

The two short edge surfaces 18 and 19, the first horizontal long edge 14, the second horizontal long edge 16, and the face surfaces 11 and 12 can be of the same material, or can be of different materials. Exemplary materials include steel, such as roll formed steel or sheet metal, aluminum, aluminum alloy, aluminum composite or combinations thereof. For example, each panel 10 can include a face surface of from about 20-gauge (about 0.0396 inches) to about 30-gauge (about 0.0157 inches) galvanized steel, or from about 18-gauge (0.0403 inches) to about 26-gauge (about 0.0159 inches) aluminum.

The panel can include one or more windows. The windows can allow passage of light through the door when in the closed position, while maintaining an air-tight seal. The window can be of any transparent material. Examples include glass, acrylic and polycarbonate. The window can be constructed to have a transparent material, such as glass, present in a single layer, or a plurality of layers.

Each panel 10 can have a thickness of from about 0.5 to about 3 inches. In some applications, a panel thickness of from about 1 to about 2 inches is preferred. The length of each panel can be selected for the size of the doorway opening to be sealed. The length of the panels can correspond to the size of any entryway, such as a residential garage. For example, the doorway opening of a typical single-car garage in the U.S. is about eight feet wide, and the doorway opening of a typical two-car garage in the U.S. is about sixteen feet wide. The panels 10 can include an extra 0.5 to 5 inches on each end to make sure that a complete seal is formed between the closed door and the doorway opening of the structure, such as a garage doorway. The height of the doorway opening of typical garages in the U.S. typically is seven or eight feet in height. Accordingly, for a sectional overhead garage door having four panels, each panel of a typical seven-foot four-panel door is about 21 inches tall, and each panel of a typical eight-foot four-panel door is about 24 inches tall.

A plurality of panels form a door. Typically, from 4 to 8 panels can be interconnected to form the door, depending on the height of the doorway opening in the structure to be closed be the door, and the height of each panel forming the door. An exemplary garage door 100 is shown in FIG. 3. In the configuration depicted in FIG. 3, the garage door 100 includes five coplanar horizontally disposed door panels 10, labelled as A, B, C, D and E in FIG. 3. The garage door 100 typically is disposed in a vertical orientation when in the closed position. When opened, the panels of the door 100 are lifted clear of the doorway opening, providing access to the interior of the structure, such as a garage.

The panels are contained in a moveable frame. The frame includes two vertical sides opposite each other, and two horizontal cross members opposite each other. Each vertical side can include a vertical track. Each vertical track can include rollers on which the panels of the door can glide. The rollers can be or contain nylon, plastic or metal or any combination thereof. One horizontal cross member is positioned at the top of the frame (relative to the ground). The two vertical side are attached to the horizontal cross member. The frame typically is larger than the doorway opening so that when engaged with the doorway opening, the panels of the door come into contact with the sealing member attached to the doorway opening.

An exemplary door system frame is shown in FIG. 3. In the configuration shown, frame 110 includes an upper horizontal cross member 125 at the top of the frame, and has vertical sides 115 and 115′, each containing a vertical track having an end portion that makes up the landing position for the door panels (vertical track 120 having an end portion forming landing portion 130 for vertical side 115 is illustrated; a corresponding vertical track 120′ having an end portion forming landing portion 130′ for vertical side 115′ is not visible in FIG. 3). Vertical tracks 120 and 120′ can include an end stop 140 and 140′ at the terminus of the tracks after the landing portions 130 and 130′. The end stops 140 and 140′ can include a vertically oriented metal sheet or beam. The end stops 140 and 140′ can help to maintain the panels 10 in the vertical position during storage when the door is in the open position.

In some configurations, a fixed support 150 attached to the ceiling of the structure via brackets also can be present. The landing portions 130 and 130′ can be positioned so that they are in contact with and supported by fixed support 150, but fixed support 150 does not interfere with the movement of frame 100 as it is moved toward or away from the doorway opening. For example, the landing portions can be attached to the fixed support by movable rails. The landing portions can act as a storage rack for the door panels when the door is in the open position.

The landing portions 130 and 130′, and the end stops 140 and 140′ when present, can include a surface coating of an elastomeric coating. The elastomeric coating can help to minimize any surface damage, such as scratches or wear, of the surfaces of the panels 10 during opening and closing of the door. The elastomeric coating can be or contain polytetrafluoroethylene, polyamide, perfluoroelastomer, rubber, vinyl, polyolefin foam, synthetic polyisoprenes, polybutadienes, polychloroprenes, chlorosulfonated polyethylenes, elastomeric polyurethanes, fluorinated elastomers, isoprene-isobutylene copolymers, ethylene-propylene-diene copolymers, styrene-isoprene-styrene block copolymers, styrene-ethylene-butylene-styrene block copolymers, and combinations thereof.

The door operating mechanism can be attached to the upper horizontal cross member 125 or to an element of the building structure, such as a beam or stud of the building. Any door operating mechanism known in the art can be used. The door operating mechanism can include a motor, gears, pulleys, chain, cable screw drive, pneumatic or hydraulic pistons or devices, or any combination thereof. An exemplary door operating mechanism 200 is shown in FIG. 3. In the configuration shown, a motor 210 is attached to a drive shaft 215 supported by vertical sides 115 and 120 in a manner in which drive shaft 215 can freely rotate when driven by motor 210, directly or indirectly, such as by gears connecting the draft shaft 215 to motor 210. The drive shaft 215 is attached on one side of the frame to a chain drive reel 220 and attached on the other side of the frame to a chain drive reel 225. A chain 230 engaged with chain drive reel 220 is attached to a coupler 240 that is attached to the short edge of the lowermost panel of the door. The chain 230 passes around pulley 245 which is supported by a suitable bracket 250. The chain 230 then returns to chain drive reel 220. The motor 210 directly or indirectly (such as through a gear mechanism) rotates drive shaft 215 in one direction to drive the chain drive reels to open the door, and rotates the drive shaft 215 in the opposite direction to drive the chain drive reels to close the door. One or more brackets can be used to attach the motor of the door operating mechanism to the ceiling or wall of the building in order to provide further support.

The frame is moveably connected to a doorway opening of a building, such as a doorway opening in a garage. The doorway opening generally is defined by a horizontal header and a pair of vertical beams located at either end of the doorway opening. The frame is moveably connected to the doorway opening using a plurality of combinations of motor driven threaded members connected to corresponding receiving members. The motor driven threaded members can be attached to the frame and the corresponding receiving members can be attached to elements of the doorway opening. The motor driven threaded members can be attached to elements of the doorway opening and the corresponding receiving members can be attached to the frame. For example, a plurality of metal plates 300 can be fixedly attached to the doorway opening 400. A metal plate 300 can be located on the interior of the building attached to each vertical beam. In some configurations, each vertical beam of the doorway opening 400 includes two metal plates spaced apart. In some configurations, each vertical beam of the doorway opening include a metal plate 300 near the bottom of the doorway opening and a metal plate 300 near the top of the doorway opening.

Each metal plate 300 includes an internally threaded opening 310. A frame motor 320 is attached to the door system frame 110, and the frame motor 320 can be attached to a threaded member 330 that is engaged with the internally threaded opening 310 in plate 300. The frame motor 320 can be in communication with the control circuit that can control the movement of the threaded member 330. The control circuit can control the amount and the direction that the threaded member 330 is rotated by frame motor 320. The threaded member 330 can be a screw or bolt. Rotation of the threaded member 330 by the frame motor 320 in one direction repositions the door system frame 110 toward the doorway opening, and rotation of the threaded member 330 by the frame motor 320 in the opposite direction repositions the door system frame 110 away from the doorway opening. For example, rotation of the threaded member 330 by the frame motor 320 clockwise can reposition the door system frame 110 toward the doorway opening, and rotation of the threaded member 330 by the frame motor 320 counterclockwise can reposition the door system frame 110 away from the doorway opening.

Alternatively, rotation of the threaded member 330 by the frame motor 320 counterclockwise can reposition the door system frame 110 toward the doorway opening, and rotation of the threaded member 330 by the frame motor 320 clockwise can reposition the door system frame 110 away from the doorway opening. The control circuit can be configured to modulate the power provided to the motor, or regulate the speed and direction and duration of movement of the motor, or permit automatic activation of the motor in response to a signal, or any combination thereof. The invention is not tied to any specific motor or type of motive device.

The threaded member 330 can be a screw or bolt or similar fastener having a screw thread that can engage with the internally threaded opening 310 in metal plate 300 attached to the vertical supports of the door frame. The internally threaded opening 310 receives the threaded member 330. The threaded member 330 attached to the frame motor 320 engages the internally threaded opening 310 in metal plate 300 to form a threaded engagement between the door system frame 110 and the doorway opening frame by which the door system frame 110 moves closer to or further from the doorway opening frame in response to the rotation of the motor-driven threaded member 330. A movable sleeve that can extend and retract can be included to shield and protect the threaded member.

The frame motor 320 can be a conventional direct-current (DC) motor driven by a power control signal, or can be a stepper motor that allows a precise amount of rotation of the threaded member by electronically controlling the number of energizing pulses supplied to the motor. The frame motor 320 can operate to rotate in the forward and reverse directions. A control circuit can be programmed to control rotation of the motor in the forward and reverse directions in response to an indication that the door is to be opened or closed. The frame motor 320 can include an electronic control unit in communication with the frame motor 320 that can be programmed to stop rotation of the stepper motor virtually instantaneously once the door system frame 110 has been moved sufficiently toward to doorway opening to sealing the doorway opening.

The doorway opening of the building to which the door system provided herein is to be attached includes a compressible elastomeric material along the length of each of the horizontal header and each vertical beams located at either end of the doorway opening and defining the doorway opening of the building. The compressible elastomeric material can be of any elastomeric material. The compressible elastomeric material can be or contain rubber, polyolefin foam, vinyl, synthetic polyisoprenes, polybutadienes, polychloroprenes, chlorosulfonated polyethylenes, elastomeric polyurethanes, fluorinated elastomers, isoprene-isobutylene copolymers, ethyl ene-propylene-diene copolymers, styrene-isoprene-styrene block copolymers, styrene-ethylene-butylene-styrene block copolymers, and combinations thereof. The elastomeric material is of a dimension sufficient to engage with the door when the frame is moved toward the doorway opening. For example, the compressible elastomeric material can have a height of from about 0.5 to about 2.5 inches. The compressible elastomeric material can have a height of from about 0.5 to about 2.5 inches. When the door in the vertical position and ready to be closed, threaded member 330 is rotated by frame motor 320 to reposition the door system frame 110 toward the doorway opening. As the door system frame approaches the doorway opening, the panels of the door come into contact with the compressible elastomeric material outlining the doorway opening, deforming the compressible elastomeric material so that an airtight seal is formed between the panels of the door and the compressible elastomeric material outlining the doorway opening.

For the bottom-most panel, the tongue portion 17 of the second horizontal long edge 16 can engage with a weather seal 22. The weather seal 22 can be of any elastomeric material. The weather seal 22 can be or contain rubber, polyolefin foam, vinyl, synthetic poly-isoprenes, polybutadienes, polychloroprenes, chlorosulfonated polyethylenes, elastomeric polyurethanes, fluorinated elastomers, isoprene-isobutylene copolymers, ethylene-propylene-diene copolymers, styrene-isoprene-styrene block copolymers, styrene-ethylene-butylene-styrene block copolymers, and combinations thereof. The weather seal 22 conforms to the floor of the building structure, such as a garage, and can accommodate horizontal movement as the frame 110 is positioned toward or away from the doorway opening by frame motors 320 attached to threaded members 330 that are engaged with the internally threaded opening 310 in plates 300. When in the closed position, the weather seal 22 forms an airtight seal between the lower door panel and the floor of the doorway opening. Frame motors 320 advantageously are quiet, particularly when compared to traditional garage door openers.

A control circuit for opening and closing the door can be a manually operated switch or a radio receiver-type switch and related circuitry, as are well known to those skilled in the art. When the door is in the down or closed position and the control circuit is activated, threaded member 330 is rotated by frame motor 320 in one direction to reposition the door system frame 110 away the doorway opening. When the frame 110 has been repositioned away from the doorway opening, motor 210 is energized and the chain drive reels 220 and 225 are turned by drive shaft 215 in one direction such that the chain 230 winds around the chain drive reel 220 and a similar chain on the other side of the frame winds around chain drive reel 225 to pull the door upward. When the door is in the up or open position and the control circuit is activated, the motor 210 is energized and the chain drive reels 220 and 225 are turned by drive shaft 215 in the opposite direction such that the chain 230 winds around the chain drive reel 220 and a similar chain on the other side of the frame winds around chain drive reel 225 to pull the door downward.

The frame includes an actuator at the top of the vertical tracks to move the panels into a vertical storage position. An exemplary actuator is shown in FIG. 3. The actuator can include a curved rail 270 and a rail 275 having a curved portion 276, a slanted portion 277 and an end 278, rails 270 and 275 being mounted on the inner surface of vertical side 120; and a corresponding curved rail 270′ and rail 275′ having a curved portion 276′, a slanted portion 277′ and end 278′, that are mounted from the inner surface of vertical side 115. As the door opens, the upper panel E encounters the actuator, and end pin 280 (with a corresponding end pin 280′ on the opposite short edge of the panel). The end pin 280 can traverse the entire length of the panel and protrude at either short edge. The end pin 280 can be attached to each short edge, such as with a bracket in combination with screws, bolts, adhesive or via welding. The end pin 280 can be an integrated portion of the panel, such as an extension of the short edge material to form the pin. Each of end pin 280 and 280′ is located in the upper portion of the short edge of the panel E and engage the rails 270 and 270′ pivoting panel E from vertical toward the horizontal position. A pair of end pins 280 and 280′ can be used instead of a single continuous end pin 280 that traverses the whole length of the panel. As the door continues to move upwardly, the panel E passes from the horizontal position and slides down the slanted portions 277 and 277′ due to the weight of the panel and off ends 278 and 278′, passing the panel to its final storage vertical position as shown in FIG. 3. The panel E is supported by pin 280 on the landing portion 130 of vertical tracks 120 and 120′. As the door continues to open, panels D, C, B, and A follow the same path as panel E, ending up in a final vertical storage position.

When panel A of the door is vertical and the door is in its fully opened position, the motor 210 is turned off. The landing portion 130 can include sensors that can signal the control circuit that the door is in the open position. The control circuit can include limit switches for limiting the upper and lower positions of the door. The control circuit also can include obstruction sensing circuitry to stop the closing of the door if an obstruction is detected that would prohibit closing of the door. Such circuits are conventional and their detailed description is not provided.

When the door is to be closed, the control circuit is energized and the motor 210 rotates in the opposite direction to drive the chain drive reels 220 and 225 in the direction opposite to that which they rotated when the door was being opened. The chain 230 will pull the door down by pulling on the coupler 240 that is attached to the short edge of the lowermost panel of the door, and each successive panel will move down the vertical tracks 120 and 120′ until the panels lock into place through intermeshing of the tongue portion and recessed groove on the panels. The threaded member 330 then is rotated by frame motor 320 in the appropriate direction to reposition the door system frame 110 toward the doorway opening. The panels of the door are brought into contact with the compressible elastomeric material outlining the doorway opening, deforming the compressible elastomeric material so that an airtight seal is formed between the panels of the door and the compressible elastomeric material outlining the doorway opening, and an airtight seal is formed between the weather seal 22 of the lower door panel and the floor of the doorway opening. The joining of the panels' adjacent edges as discussed above form an airtight seal between the panels when the door is in the closed position. In addition, as discussed above, recessed groove can include a compressible elastomeric material to enhance forming the airtight seal between the joined panels.

In case of a power failure, the system can include a back-up power supply. The back-up power supply can include a battery to energize the frame motors 320 to move the frame 110 away from the doorway opening and to energize motor 210 to move the door panels 10 to place the door 100 in the open position. The door system also can be operated manually.

The door system provided herein can produce less noise when moving the door into an open or closed position than produced by traditional garage doors. Quiet motors, such as stepper motors and conventional DC motors driven by a power control signal can be selected that result in the product of little noise, resulting in quiet operation of the door system. The actuator of the door system that places the door panels in a stacked vertical (or horizontal) position for storage can include rollers and noise dampening material to further produce a quiet operating door system. The storage of the door as collapsed panels in a vertical orientation allows for better utilization of garage storage, freeing up a significant amount of square footage in the ceiling area normally occupied by the door in traditional garage door systems. The airtight seal produced by the door system prevents entry of wind, rain, insects, pests and vermin into the garage. The door system thus promotes energy efficiency and cleanliness of the garage.

Many different types of motive power are capable of use for opening and closing the door of the systems provided herein, and the provided systems are not limited to a particular device or manner so capable. A mechanical, electromechanical, electrical, hydraulic, or pneumatic system can be provided to supply motive power to drive the opening and closing of the door. When an electro-mechanical system is used, it is not limited in the manner in which the electro-mechanical system receives electrical power. For example, the electro-mechanical system can receive electrical power from a remotely located solar panel, or a battery located locally or remotely, or electrical power from line voltage via the structure in which the door system is installed.

The door systems provided herein can include a mechanical locking system or electronic locking system or a combination thereof. The door systems can include a thermometer or humidity meter. The door systems can include a dehumidifier. The door systems can include an air conditioning system, that can dehumidify the air as well as modify the temperature of the air within the garage or building. The door systems can include a color-coordinated lighting system to convey information. The door systems can include a blower system, which can be configured, for example, to remove debris or water from a car as it enters the garage and passes over the blower system. The door systems can include a ventilation system. The door systems can include an automatic timer. Also provided is a door system that includes a plurality of panels, movable and positionable along guide rails to open and close an opening horizontally, wherein the panels are moved in a direction along the guide rails by a combination of movable trolleys, where the movable trolley runs inside of a guide profile and reposition the panels from an orientation parallel to the opening to an orientation perpendicular to the opening and stack the panels abutting each other to form a compact storage of the panels.

Every component of the system can be built into a pre-made frame and delivered to the customer for installation. The upper and lower tracks are placed along the horizontal axis of the building opening, guiding the panels as they move to open the door, resulting in the panels being stacked against each other, resulting in a compact stack that can be stored in a storage space. The storage space can be built into the frame on either side of the opening or on both sides of the opening. When opened from the middle so that the panels are stored on each side of the opening, two motors can be used to move the panels to each side of the building opening into their respective storage space. When the door panels are extended across the horizontal axis to close the opening, a locking mechanism can be used to secure the doors. Any locking mechanism known in the art can be used (e.g., see U.S. Pat. No. 6,382,005 (White et al., 2002).

Also provided are methods for sealing an opening of a garage or other structure for keeping out the elements, as well as dirt, dust, insects and pests. The methods include providing a sectional door system providing herein where the door contains a plurality of panels, the panels including a tongue portion and the recessed groove, where the intermeshing of the tongue and groove of two adjacent panels prevent movement of air, dirt, dust, insects or pest through the door when in the closed position. The methods also include providing a door system frame that is movably attached to the structure, and positioning the door against a sealing member fixed to the structure to form a seal. The door system frame is moveably connected to a doorway opening of a structure, such as an opening in a garage, using an electro-mechanical connector, an electric-hydraulic connector, a hydraulic connector, a pneumatic connector, an electro-pneumatic connector, a solenoid valve connector, a mechanical spring connector, or a combination thereof. The movable connector can include an electric actuator, a mechanical actuator, a hydraulic actuator, a pneumatic actuator, an electro-mechanical actuator, an electric-hydraulic actuator, an electro-pneumatic actuator, a piston rod cylinder, a rodless cylinder, an electric cylinder, an electric linear actuator, a pneumatic linear actuator, a hydraulic linear actuator, and combinations thereof.

In the methods provided herein, the panels of the door system provided herein are positioned to their closed position, in which the tongue portion of one panel is received into the recessed groove of an adjacent panel, joining the panels and inhibiting the passage of air therebetween. Once all of the panels of the door have intermeshed, the movable door frame is moved toward the sealing member around the doorway opening by activation of the connector. The connector advances the frame until the panels are in contact with and form a seal with the sealing member.

Also provided are methods for reversibly converting a garage space into a living space. The methods include sealing any vents or drains in the garage and installing a door system provided herein, the system including a sealing member fixed about the opening of the garage, a panel door and a frame that is movably attached to the opening of the garage, and activating a movable connector to position the door against the sealing member fixed about the garage door opening to form a seal. A pressure regulator is included to allow ventilation and maintain ambient pressure within the converted living space. The pressure regulator allows a properly balanced inflow and outflow of air to maintain appropriate ambient pressure within the living space with changes in barometric and/or atmospheric pressure, such as caused by changes in weather or wind. The pressure regulator can include inlet and outlet flow valves that will automatically operate to prevent overly low or high pressures within the living space relative to the outside pressure by admitting outside air should the external atmosphere tend to increase over the internal pressure, or by venting inside air externally should the external pressure decrease relative to the internal pressure within the living space. The flow valves can include solenoids that can be controlled manually or automatically by or in accordance with pressure-sensitive devices.

The door system frame can be moveably connected to the opening in the garage using an electro-mechanical connector, an electric-hydraulic connector, a hydraulic connector, a pneumatic connector, an electro-pneumatic connector, a solenoid valve connector, a mechanical spring connector, or a combination thereof. In the methods provided herein, the panels of the door system provided herein are positioned to their closed position, in which the tongue portion of one panel is received into the recessed groove of an adjacent panel, joining the panels and inhibiting the passage of air therebetween, or the extended positive half-lap joint of one panel fits is received into the cutaway negative half-lap joint of the adjoining panel, thereby joining the first panel to the second panel and inhibiting the passage of air therebetween. Once all of the panels of the door have intermeshed, the movable door frame is moved toward the sealing member around the doorway opening by activation of the movable connector. The movable connector advances the frame until the panels are in contact with and form a seal with the sealing member about the garage opening. The system can include an air handling system that can circulate fresh filtered air into the garage. The system can include an air conditioning system to regulate the humidity or temperature or both within the reclaimed garage space. The methods also can include installing duct work that allows the reclaimed space to be tied into the building's existing heating or cooling systems.

While various embodiments of the subject matter provided herein have been described, it should be understood that they have been presented by way of example only, and not limitation. Since modifications will be apparent to those of skill in this art, it is intended that this invention be limited only by the scope of the appended claims.

### LIST OF FIGURE ELEMENTS

| | | | |
|---|---|---|---|
| 10 | Panel | | |
| 11 | Interior face surface | | |
| 12 | Exterior face surface | | |
| 13 | Core | | |
| 14 | First horizontal long edge | | |
| 15 | Recessed groove | | |
| 16 | Second horizontal long edge | | |
| 17 | Tongue portion | | |
| 17′ | Tongue portion | | |
| 18 | Short edge | | |
| 19 | Short edge | | |
| 20 | Side compressible elastomeric material | | |
| 21 | Bottom compressible elastomeric material | | |
| 22 | Weather seal | | |
| 25 | Metal insert | | |
| 50 | Panel end coupling | | |
| 50′ | Panel end coupling | | |
| 100 | Door | | |
| 105 | Building vertical beam | | |
| 110 | Frame | | |
| 115 | Vertical side | | |
| 115′ | Vertical side | | |
| 120 | Vertical track | | |
| 120′ | Vertical track | | |
| 125 | Upper horizontal cross member | | |
| 130 | Landing portion | | |
| 130′ | Landing portion | | |
| 140 | End stop | | |
| 140′ | End stop | | |
| 150 | Fixed support | | |
| 200 | Door operating mechanism | | |
| 210 | Motor | | |
| 215 | Drive shaft | A | Panel |
| 220 | Chain drive reel | B | Panel |
| 225 | Chain drive reel | C | Panel |
| 230 | Chain | D | Panel |
| 240 | Coupler | E | Panel |
| 245 | Pulley | | |
| 250 | Bracket | | |
| 270 | Curved rail | | |
| 270′ | Curved rail | | |
| 275 | Rail | | |
| 275′ | Rail | | |
| 276 | Curved portion | | |
| 276′ | Curved portion | | |
| 277 | Slanted portion | | |
| 277′ | Slanted portion | | |
| 278 | End | | |
| 278′ | End | | |
| 280 | End pin | | |
| 280′ | End pin | | |
| 300 | Metal plate | | |
| 310 | Threaded opening | | |
| 320 | Frame motor | | |
| 330 | Threaded member | | |
| 400 | Doorway opening | | |
| 500 | Opening sealing element | | |
| 525 | Building vertical beam | | |
| 550 | Movable connector | | |
| 575 | Pivot joint | | |
| 600 | Upper movable connector | | |
| 650 | Lower movable connector | | |

1. A sectional door system for closing an opening in a building, the system comprising:
a plurality of panels, each panel comprising:
a first face surface;
a second face surface;
a core;
a first horizontal long edge containing a recessed groove and an opposite second horizontal long edge including a tongue portion, or a first horizontal long edge containing a positive of a half-lap joint, and an opposite second horizontal long edge containing a negative of a half-lap joint;
a first vertical short edge on one end; and
a second vertical short edge on the opposite end;
a frame within which the panels can move;
an operating mechanism for opening and closing the door vertically by moving the panels within the frame;
a sealing member attached about the opening in the building; and
a movable connector for movably connecting the frame to the building for reversibly engaging the panels with the sealing member to form an airtight seal.

2. The system of claim 1, wherein:
the tongue portion of one panel is insertable in the recessed area of an adjacent panel to join the panels and inhibit the passage of air therebetween; or
the positive half-lap joint of one panel fits into the cutaway negative half-lap joint of the adjoining panel, thereby joining the first panel to the second panel and inhibiting the passage of air therebetween.

3. The system of claim 1, wherein the core:
a) comprises a unitary expanded polymeric material; or
b) has a honeycomb design; or
c) comprises an aerogel; or
d) comprises a plurality of insulation microspheres; or
e) comprises one or more vacuum insulated panels; or
f) any combination of a), b), c), d) and e).

4. The system of claim 3, wherein the core comprises an expanded polymeric material comprising a polystyrene foam or polyurethane foam or a combination thereof.

5. The system of claim 1, wherein the panel:
a) comprises an insulating material to reduce the transmission of thermal energy or sound energy or both; or
b) comprises a layered composite construction, with different materials layered during fabrication of the panel; or
c) has no visible seams; or
d) has a thermal resistance or R value ranging from 30 to 60; or
e) any combination of a), b), c) and d).

6. The system of claim 1, wherein:
the first face surface of the panel faces external to the opening of the building or structure; and
the second face surface of the panel faces internal to the opening of the building or structure.

7. The system of claim 1, wherein:
a) the first face surface and second face surface each comprise a material independently selected from among plastic, aluminum, aluminum alloy, aluminum composite, carbon fiber, and steel; or
b) the first face surface or second face surface or both comprises a thermoplastic resin, or resin reinforced fiberglass, or carbon-fiber-reinforced plastic, or a composite or a combination thereof; or
c) the first face surface or second face surface comprises epoxide resin based carbon fiber-reinforced plastic; or
d) the first face surface or second face surface comprises acrylonitrile butadiene styrene copolymer (ABS), polycarbonate acrylonitrile butadiene styrene copolymer (PC/ABS), polyether-ether-ketone (PEEK), polyetherketone ketone (PEKK), polyetherimide (PEI), polypropylene (PP), polyphenylene sulfide (PPS), polyvinyl chloride (PVC), or a thermoplastic olefin (TPO) or any combination thereof; or
e) any combination of a), b), c) and d).

8. The system of claim 1, wherein the panels further comprise a surface coating.

9. The system of claim 8, wherein:
a) the surface coating comprises a thermoplastic elastomer, a thermoplastic vulcanizate or an aromatic polyurea/polyurethane hybrid elastomer system or combinations thereof, or
b) the surface coating comprises a Line-X® brand aromatic polyurea/polyurethane hybrid protective coating; or
c) the surface coating is on an internal surface of the panel, or the first face surface, or the second face surface or any combination thereof; or
d) any combination of a), b) and c).

10. The system of claim 1, wherein the panels comprise a shrapnel slowing material selected from among an aramid material, a para-aramid material, a boron carbide tile, a carbon fiber composite material, ballistic nylon, ballistic fiberglass, ballistic polyethylene composite, an ultra-high molecular weight polyethylene fiber, a carbon fiber composite comprising an ultra-high molecular weight polyethylene fiber, aceramic tile, and a combination thereof.

11. The system of claim 1, wherein the tongue portion of each panel comprises a metal insert, and:
a) the metal insert has a shape selected from among a rod, a strip, a square bar, a rectangular bar, a hexagonal bar, a sheet and a corrugated sheet; or
b) the metal insert extends into the core of the panel; or
c) both a) and b).

12. The system of claim 1, wherein the core is between the first face surface and second face surface of the panels and adhesively bonded thereto to form a unitary unit.

13. The system of claim 1, wherein at least one panel comprises a window.

14. The system of claim 13, wherein the window:
a) comprises a polymer film that comprises a polyvinylbutyral (PVB) or ethylene vinyl acetate (EVA) or a combination thereof; or
b) comprises a privacy glass; or
c) comprises an electro-chromic element; or
d) comprises at least two layers of transparent material separated by a space, wherein the space between the two layers of transparent material is evacuated or filled with an inert gas; or
e) comprises a transparent metal oxide layer that can reflect at least one wavelength of electromagnetic radiation; or
f) any combination of a), b), c), d) and e).

15. The system of claim 1, wherein at least one panel comprises a decorative design or embossment.

16. The system of claim 15, wherein:
a) the decorative design or embossment is on a face surface positioned toward the exterior environment or toward the interior of the building or both; or
b) the panel has one decorative design or embossment on one face surface and a different decorative design or embossment on the other face surface; or
c) both a) and b).

17. The system of claim 1, wherein at least one face surface comprises a coating selected from among a paint, a pigment, a vinyl cladding, a baked-on polyester finish, melamine, a powder coating, an anti-corrosive coating, a galvanizing coating, and any combination thereof.

18. The system of claim 1, further comprising an interchangeable cover that can be fastened to the first face surface or the second face surface or both to change the aesthetic appearance of the door.

19. The system of claim 1, wherein the panels have a thickness of from at or about 0.5 to at or about 3 inches (at or about 1.27 cm to at or about 7.62 cm).

20. The system of claim 1, further comprising a coupling joining adjacent panels, wherein:
a) the coupling secures adjacent panel members together along adjoining first and second horizontal long edges; or
b) the coupling secures adjacent panel members together along adjoining first and second vertical short edges.

21. The system of claim 20, wherein the coupling comprises:
a) a hinge; or
b) a slidable ring that encircles a first peg on one panel and a second peg on an adjacent panel and is configured to couple the first and the second pegs while allowing the panels to rotate about their horizontal long edges.

22. The system of claim 1, wherein a surface of the recessed groove or a surface of the negative of the half-lap joint further comprises a compressible elastomeric material.

23. The system of claim 22, wherein the compressible elastomeric material comprises rubber, vinyl, polyolefin foam, synthetic polyisoprenes, polybutadienes, polychloroprenes, chlorosulfonated polyethylenes, elastomeric polyurethanes, fluorinated elastomers, isoprene-isobutylene copolymers, ethylene-propylene-diene copolymers, styrene-isoprene-styrene block copolymers, styrene-ethylene-butylene-styrene block copolymers, or a combination thereof.

24. The system of claim 1, wherein the recessed groove has a shape selected from among rectangular, tapered and U-shaped.

25. The system of claim 1, wherein the frame further comprises a pair of vertical tracks and the panels are positioned between the vertical tracks.

26. The system of claim 25, wherein the vertical tracks contain rollers that allow the panels to move within the track without contacting the track directly.

27. The system of claim 26, wherein:
a) the rollers comprise a material selected from among nylon, plastic, wood and metal; or
b) the rollers comprise a coating selected from among an elastomeric coating, a polymer coating, a Teflon coating, a plastic coating and a nylon coating; or
c) both a) and b).

28. The system of claim 25, wherein:
a) each of the vertical tracks comprises a first straight section that is parallel to the opening of the building or structure; or
b) each of the vertical tracks comprises a curved portion near the top of the opening of the building or structure positioned toward the inside of the building; or
c) each of the vertical tracks comprises a distal second straight section that is parallel to and spaced from the ceiling of the structure; or
d) at least one of the vertical tracks further comprises a limit switch that de-energizes the operating mechanism when contacted; or
e) any combination of a), b), c) and d).

29. The system of claim 1, wherein the frame further comprises a horizontal cross member.

30. The system of claim 1, further comprising a fixed support fixedly attached to the structure.

31. The system of claim 30, wherein the fixed support is attached to the ceiling of the structure.

32. The system of claim 25, wherein the tracks of the frame are attached via movable rails to a fixed support fixedly attached to the structure.

33. The system of claim 30, wherein the fixed support is configured to accept the terminal portion of the frame without interfering with the movement of frame as it is moved toward or away from the opening of the building or structure.

34. The system of claim 25, wherein at least one of the tracks of the frame includes an end stop at its terminus.

35. The system of claim 34, wherein at least a portion of the terminus of the tracks or the end stop or both include a surface coating.

36. The system of claim 35, wherein the surface coating comprises an elastomeric coating comprises a polytetrafluoroethylene, polyamide, perfluoroelastomer, rubber, vinyl, polyolefin foam, synthetic polyisoprenes, polybutadienes, polychloroprenes, chlorosulfonated polyethylenes, elastomeric polyurethanes, fluorinated elastomers, isoprene-isobutylene copolymers, ethyl ene-propylene-diene copolymers, styrene-isoprene-styrene block copolymers, styrene-ethylene-butylene-styrene block copolymers, or a combination thereof.

37. The system of claim 1, further comprising:
a) a light activated when the operating mechanism is energized; or
b) a receiver responsive to a transmitter; or
c) an obstruction sensor or a reverse trip switch or both; or
d) a manual switch to deactivate the door system; or
e) a manual system to open the door in case of power failure; or
f) a carbon monoxide sensor and an alarm; or
g) a smoke detector and an alarm; or
h) an infrared tripping sensor; or
i) a variable resistance sensor; or
j) a particle detector or air quality sensor; or
k) a back-up power supply; or
l) any combination of a) through k).

38. The system of claim 1, further comprising a computer module comprising a computer.

39. The system of claim 38, wherein:
a) the computer is in communication with and/or in control of at least one component of the door system; or
b) the computer communicates with a control system to automate or operate the opening and closing of the door; or
c) the computer communicates with a control system to operate a light, a mechanical component, an operating mechanism, a touch panel, or automatic closing and locking mechanisms or any combination thereof; or
d) the computer comprises a non-transitory computer-readable storage medium having a computer-readable program embodied therein for directing operation of the door system and/or any component of the system; or
e) any combination of a), b), c) and d).

40. The system of claim 1, wherein:
a) the system is configured to interact with a smart house product; or
b) the system is configured to interact with a smart phone.

41. The system of claim 1, wherein the sealing member comprises a compressible material that is reversibly deformable and conforms in shape to the surface of an object brought into contact with the sealing member.

42. The system of claim 41, wherein the compressible material comprises:
a) a sponge rubber or a foamed plastic or a plastic resin or a compressible elastomeric material comprising rubber, vinyl, polyolefin foam, synthetic polyisoprenes, polybutadienes, polychloroprenes, chlorosulfonated polyethylenes, elastomeric polyurethanes, fluorinated elastomers, isoprene-isobutylene copolymers, ethylene-propylene-diene copolymers, styrene-isoprene-styrene block copolymers, styrene-ethylene-butylene-styrene block copolymers, or a combination thereof; or
b) the sealing member comprises a resilient semi-circular strip of elastomeric compressible material; or
c) the sealing member comprises a hollow opening in the interior of the sealing member that extends the length of the material; or
d) the sealing member comprises an elastomeric reservoir containing a quantity of fluid secured to a header above the opening of the building or structure and spaced tubular elastomeric members secured at each side of the door opening to the building structure, where fluid forced into the tubular members extend them into sealing contact with the side edges of the panels of the door; or
e) any combination of a), b), c) and d).

43. The system of claim 1, wherein the movable connector comprises:
a) an electro-mechanical connector, an electric-hydraulic connector, a hydraulic connector, a pneumatic connector, an electro-pneumatic connector, a solenoid valve connector, a mechanical spring connector, or a combination thereof; or
b) an electric actuator, a mechanical actuator, a hydraulic actuator, a pneumatic actuator, an electro-mechanical actuator, an electric-hydraulic actuator, an electro-pneumatic actuator, a piston rod cylinder, a rodless cylinder, an electric cylinder, an electric linear actuator, a pneumatic linear actuator, a hydraulic linear actuator, or a combination thereof; or
c) a pair of arms, disposed symmetrically around a central axis, and a piston to push the arms apart or to pull the arms together, thereby bringing the frame toward or away from the building or structure opening, wherein the piston is operated electrically, hydraulically or pneumatically; or
d) a gear attached to a drive shaft, a motor, and a cable or chain driven by the motor to rotate the gear and drive shaft to reposition the frame of the door closer to or away from the building or structure opening; or
e) any combination of a), b), c) and d).

44. The system of claim 1, wherein the movable connector comprises a threaded member that can:
a) move the frame toward the building or structure to engage with the sealing member to form a seal; and
b) move the frame away from the building or structure to disengage with the sealing member.

45. The system of claim 44, further comprising a pair of metal plates that contain an internally threaded opening that accepts the threaded member, wherein one metal plate of the pair is attached to an element of the building or structure, and the other metal plate of the pair is attached to the frame, and rotation of the threaded member by a motor in one direction repositions the frame toward the opening of the building or structure, and rotation of the threaded member by the motor in the opposite direction repositions the frame away from the opening of the building or structure.

46. The system of claim 45, wherein the motor is a direct-current motor driven by a power control signal or a stepper motor.

47. The system of claim 45, further comprising a control circuit programmed to control a rotation of the motor in a forward direction and a reverse direction.

48. The system of claim 1, wherein the door operating mechanism comprises:
a) a mechanical opener, an electromechanical opener, an electrical opener, a hydraulic opener, a pneumatic opener or combinations thereof; or
b) an electric motor, a chain drive mechanism, and a length of a bicycle-type chain geared to the chain drive mechanism driven by the electric motor;
c) an electric motor, a drive mechanism, and a length of toothed belt geared to the drive mechanism driven by the electric motor; or
d) any combination of a), b) and c).

49. The system of claim 1, wherein the door operating mechanism comprises a pair of actuator arms that can lift and stack the panel members of the door into a stack, and optionally a rail or track on which the actuator arms are mounted.

50. The system of claim 49, wherein the actuator arms include a clamp or fingers at their distal ends to engage with the panel, and the clamp or fingers are operated electrically, hydraulically or pneumatically.

51. The system of claim 1, further comprising a weather seal attached to the tongue portion or a groove portion of the bottom-most panel.

52. The system of claim 1, further comprising:
a) a mechanical locking system or electronic locking system or a combination thereof; or
b) a thermometer or humidity meter; or
c) a color-coordinated lighting system to convey information; or
d) a blower system; or
e) a ventilation system; or
f) an automatic timer; or
g) any combination of a), b), c), d), e) and f).

53. A method for sealing an opening of a garage or other structure, comprising:
providing a sectional door system of claim 1;
activating the operating mechanism to position the panels in their closed position, in which the tongue portion of one panel is received into the recessed groove of an adjacent panel, joining the panels and inhibiting the passage of air therebetween; and
activating the movable connector to advance the frame until the panels are in contact with and form a seal with the sealing member.

54. A method for reversibly converting a garage space into a living space, comprising:
installing a pressure regulator;
sealing any vents or drains in the garage; and
installing the door system of claim 1 to seal the opening of the garage.
